(19) United States
(12) Patent Application Publication
(10) Pub. No.: US 2020/0032580 A1
(43) Pub. Date: Jan. 30, 2020

(54) MOUNTING SYSTEM FOR A VERTICAL CELLULAR DRAPE AND A RELATED COVERING ASSEMBLY

(71) Applicant: Hunter Douglas Inc., Pearl River, NY (US)

(72) Inventor: Toralf H. Strand, Kittery, ME (US)

(21) Appl. No.: 16/520,700

(22) Filed: Jul. 24, 2019

Related U.S. Application Data
(60) Provisional application No. 62/702,980, filed on Jul. 25, 2018.

(51) Int. Cl. E06B 9/36; E06B 9/38

(52) U.S. Cl. CPC E06B 9/36; E06B 9/38

(57) ABSTRACT

In one aspect, a mounting system for mounting a vertical cellular drape relative to an architectural structure includes a rail and a plurality of carrier assemblies configured to support the cellular drape relative to the rail. The carrier assemblies are movable along the length of the rail to support the cellular drape as it is moved between an extended position and a retracted position to at least partially cover or expose the adjacent architectural structure, as desired. Additionally, in one embodiment, the various components and/or features of the mounting system may provide unique and/or desired advantages when supporting the vertical cellular drape relative to the architectural structure.

### CROSS-REFERENCE TO RELATED APPLICATIONS

This application is based upon and claims the right of priority to U.S. Provisional Patent Application No. 62/702,980, filed Jul. 25, 2018 and entitled “Mounting System for a Vertical Cellular Drape and a Related Covering Assembly,” the disclosure of which is hereby incorporated herein in its entirety for all purposes.

### FIELD OF THE INVENTION

The present disclosure relates generally to covering assemblies for architectural structures and, more particularly, to a mounting system for mounting a vertical cellular drape relative to an architectural structure, such as a window or a sliding glass door.

### BACKGROUND OF THE INVENTION

Draperies are a popular type of covering used in residential and commercial applications to cover a window, door, and/or other architectural structure. Drapes are typically made from a single panel of fabric which is hung or suspended vertically from a rod or other carrier. The suspended drape may then be moved laterally or horizontally to cover or expose the adjacent architectural structure, as desired. Conventionally, drapes have been manufactured using a panel of fabric having a wavy profile formed from alternating, “soft” rounded bends. As a result, a typical drape will tend to splay outwardly in all directions as it descends from the drape's constrained top. In addition, such a drape configuration typically creates a very large collection or gathering of material when the drape is moved to the retracted position along the side of the architectural structure, which can be aesthetically undesirable and also occupies a large amount of floor/window space. Moreover, conventional drapes are often difficult to package and can be quite labor-intensive for the drapery installer.

The design emphasis in home and building structures has maintained pressure on the industry to continue to create new and improved draperies for architectural structures that provide a unique, aesthetically attractive appearance for the room in which a drape(s) is installed while also exhibiting the desired light transmission/blocking properties and/or the desired insulation properties for the covering. For example, U.S. application Ser. No. 15/414,718, entitled “Vertical Cellular Drape for an Architectural Structure” and filed Jan. 25, 2017, which is commonly owned by the assignee of the present application and the disclosure of which is hereby incorporated by reference herein in its entirety for all purposes, discloses an improved vertical cellular drape for an architectural structure. While such vertical cellular drape addresses various issues associated with conventional drapes, including the inability to move a conventional drape to the retracted position without creating a large collection or gathering of material, a need still exists in the art for suitable mounting hardware and related systems that can be used to efficiently and effectively mount a vertical cellular drape, including the drape disclosed in U.S. application Ser. No. 15/414,718, relative to an architectural structure. Specifically, a need exists for a mounting system configured for use with a vertical cellular drape that allows the drape to be properly supported relative to an architectural structure in both the extended and retracted positions while complementing the functional advantages that can be achieved using a vertical cellular drape as compared to conventional “fabric panel” drapes.

Accordingly, an improved mounting system for mounting a vertical cellular drape relative to an architectural structure would be welcomed in the technology.

### BRIEF DESCRIPTION OF THE INVENTION

Aspects and advantages of the present disclosure will be set forth in part in the following description, or may be obvious from the description, or may be learned through practice of the present disclosure.

In various aspects, the present disclosure is directed to a mounting system for mounting a vertical cellular drape relative to an architectural structure, such as a window or door, as well as a related covering assembly including both a vertical cellular drape and an associated mounting system. In one embodiment, the mounting system may include a rail and a plurality of carrier assemblies configured to be coupled between the rail and the cellular drape. The carrier assemblies may be movable along the length of the rail to support the cellular drape as it is moved between an extended position and a retracted position to at least partially cover or expose an adjacent architectural structure, as desired.

As will be described below, the various components, features, and/or structure of the mounting system may provide unique and/or desired advantages when supporting a vertical cellular drape relative to an architectural structure. For instance, in one embodiment, the dimensions of one or more components of the mounting system may be selected to provide the associated vertical cellular drape with a desired amount of fullness or cross-wise depth when the drape is moved to the extended position while still allowing the drape to be collapsed down to a desired lateral width when moved to the retracted position.

These and other features, aspects and advantages of the present disclosure will become better understood with reference to the following Detailed Description and appended claims. The accompanying drawings, which are incorporated in and constitute a part of this specification, illustrate embodiments of the present disclosure and, together with the description, serve to explain the principles of the present disclosure.

This Brief Description is provided to introduce a selection of concepts in a simplified form that are further described below in the Detailed Description. This Brief Description is not intended to identify key features or essential features of the claimed subject matter, nor is it intended as an aid in determining the scope of the claimed subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates a perspective view of one embodiment of a covering assembly including a vertical cellular drape and an associated mounting system in accordance with aspects of the present disclosure, particularly illustrating the cellular drape in an extended position relative to an adjacent architectural structure (not shown);

FIG. 2 illustrates another perspective view of the covering assembly shown in FIG. 1, particularly illustrating the cellular drape moved to a retracted position relative to the architectural structure;

FIG. 3 illustrates a cross-sectional view of the cellular drape shown in FIG. 1 taken about line particular illustrating an example configuration for the cellular drape when in the extended position;

FIG. 4 illustrates another cross-sectional view of the cellular drape similar to that shown in FIG. 3, particularly illustrating an example configuration for the cellular drape when in a partially retracted position;

FIG. 5 illustrates a rear perspective view of a portion of the covering assembly shown in FIG. 1, particularly illustrating one embodiment of the mounting system of the covering assembly in accordance with aspects of the present disclosure;

FIG. 6 illustrates an end view of a rail of the mounting system shown in FIG. 5;

FIG. 7 illustrates another end view of the rail of the mounting system shown in FIG. 5, particularly illustrating an end carrier and an associated support bracket installed relative to the rail;

FIG. 8 illustrates a perspective view of a carrier assembly of the mounting system shown in FIG. 5, particularly illustrating the carrier assembly positioned relative to adjacent spacers of the mounting system of the covering assembly in accordance with aspects of the present disclosure;

FIG. 9 illustrates another end view of the rail of the mounting system shown in FIG. 5, particularly illustrating the carrier assembly shown in FIG. 8 installed relative to the rail;

FIG. 10 illustrates a cross-sectional view of the carrier assembly shown in FIG. 8 taken about line X-X; and

FIG. 11 illustrates a perspective view of a plurality of carrier assemblies of the mounting system shown in FIG. 5 provided in a laterally stacked arrangement or configuration in accordance with aspects of the present disclosure;

FIG. 12 illustrates another rear perspective view of a portion of the covering assembly shown in FIG. 1, particularly illustrating another embodiment of the mounting system of the covering assembly including external spacers in accordance with aspects of the present disclosure;

FIG. 13 illustrates a top view of a portion of the covering assembly shown in FIG. 11, particularly illustrating another embodiment of external spacers that can be utilized within the disclosed mounting system in accordance with aspects of the present disclosure;

FIG. 14 illustrates a perspective view of another embodiment of a covering assembly including a vertical cellular drape and an associated mounting system in accordance with aspects of the present disclosure, particularly illustrating the cellular drape in an extended position relative to an adjacent architectural structure (not shown);

FIG. 15 illustrates another perspective view of the covering assembly shown in FIG. 14, particularly illustrating the cellular drape moved to a retracted position relative to the architectural structure;

FIG. 16 illustrates a rear perspective view of a portion of the covering assembly shown in FIG. 14, particularly illustrating one embodiment of the mounting system of the covering assembly in accordance with aspects of the present disclosure;

FIG. 17 illustrates an end view of a rail of the mounting system shown in FIG. 16;

FIG. 18 illustrates a perspective view of an intermediate carrier assembly of the mounting system shown in FIG. 16, particularly illustrating the carrier assembly positioned relative to adjacent spacers of the mounting system of the covering assembly in accordance with aspects of the present disclosure;

FIG. 19 illustrates another end view of the rail of the mounting system shown in FIG. 16, particularly illustrating the intermediate carrier assembly shown in FIG. 18 installed relative to the rail;

FIG. 20 illustrates a cross-sectional view of the intermediate carrier assembly shown in FIG. 18;

FIG. 21 illustrates a perspective view of an end carrier assembly of the mounting system shown in FIG. 16, particularly illustrating the carrier assembly positioned relative to an adjacent spacer of the mounting system of the covering assembly in accordance with aspects of the present disclosure;

FIG. 22 illustrates a cross-sectional view of the end carrier assembly shown in FIG. 21 taken about line XXII-XXII;

FIG. 23 illustrates a perspective view of a plurality of carrier assemblies of the mounting system shown in FIG. 16 provided in a laterally stacked arrangement or configuration in accordance with aspects of the present disclosure; and

FIG. 24 illustrates another end view of the rail of the mounting system shown in FIG. 16, particularly illustrating an optional support bracket installed relative to the rail.

### DETAILED DESCRIPTION OF THE INVENTION

In general, the present disclosure is directed to a mounting system for mounting a vertical cellular drape relative to an architectural feature or structure (referred to herein simply as an architectural “structure” for the sake of convenience without intent to limit), such as a window or door. In addition, the present disclosure is also directed to a covering assembly that includes both a vertical cellular drape and an associated mounting system for mounting the vertical cellular drape relative to an adjacent architectural feature.

In one aspect, the present disclosure is directed to a covering assembly for an architectural structure that includes a vertical cellular drape and a mounting system configured to support the cellular drape relative to an architectural structure. In one embodiment, the cellular drape extends in a vertical direction between a top end and a bottom end and in a lateral direction between a first lateral end and a second lateral end. The cellular drape is movable in the lateral direction between an extended position and a retracted position. Additionally, the cellular drape includes a front drape panel defining a front face of the cellular drape and a rear drape panel defining a rear face of the cellular drape opposite the front face, with the front and rear faces being spaced apart from each other in a cross-wise direction.

In one embodiment, the front and rear drape panels may be spaced apart from each other in the cross-wise direction when the drape is moved to the extended position such that a plurality of internal cells are defined between the drape panels, with each internal cell being separated or divided from adjacent internal cells by a divider or rib extending between the front and rear drape panels. Additionally, in one embodiment, the front and rear drape panels define interleaved pleats between the front and rear faces of the cellular drape that allow the cellular drape to be collapsed into a folded or accordion-style configuration having a substantially flattened cellular profile when in the retracted position.

Moreover, in one embodiment, the mounting system of the covering assembly includes a rail and a plurality of carrier assemblies configured to be coupled between the rail and the cellular drape. Each carrier assembly includes a carrier movably coupled to the rail. Additionally, in one embodiment, each carrier assembly includes a drape connector configured to be coupled between the carrier and the cellular drape.

In one embodiment, the rail of the covering assembly extends in the lateral direction between a first end and a second end and in the vertical direction between a top side and an opposed bottom side. The rail also extends in the cross-wise direction between a front side configured to generally face in the same direction as the front face of the cellular drape and a rear side opposite the front side. Additionally, the rail defines a mounting slot in which the carriers are configured to be mounted.

In one embodiment, the cellular drape defines a lateral width when it is moved to the retracted position. Additionally, in one embodiment, a lateral dimension associated with the carrier assemblies is selected to minimize the lateral width of the cellular drape when the associated carriers are moved into abutting engagement with one another as the drape is moved to the retracted position. Specifically, in one embodiment, it may be desirable to make the carrier assemblies as compact as possible to minimize the lateral width or profile of the cellular drape when at the retracted position, thereby allowing the cellular drape to be collapsed into the desired folded or accordion-style configuration. For example, in one embodiment, the effective lateral thickness of each carrier assembly may be less than about one inch, such as approximately 0.25 inches.

In one embodiment, the carriers of the carrier assemblies include a plurality of intermediate carriers configured to be coupled to the cellular drape at spaced apart locations in the lateral direction between the first and second lateral ends of said cellular drape. In such an embodiment, the intermediate carriers may be designed such that the lateral thickness of each intermediate carrier is minimized, thereby allowing the overall lateral width of the assembly to be reduced. Additionally, in one embodiment, at least one of the carriers of the carrier assemblies includes an end carrier configured to be coupled to the cellular drape adjacent to one of the drape's lateral ends. In one embodiment, the end carrier may be configured such that a lateral spacing width defined between an end face of the end carrier (e.g., an end face configured to abut against an adjacent intermediate carrier when the cellular drape is moved to the retracted position) and a location at which the cellular drape is coupled to the end carrier is minimized, thereby allowing the overall lateral width of the assembly to be reduced.

In one embodiment, the covering assembly further includes a plurality of spacers installed relative to the rail and/or the cellular drape. In one embodiment, each spacer extends lengthwise between a first end and a second end and defines a spacer length between the spacer's first and second ends. Additionally, in one embodiment, the spacer length is selected to set a maximum peak-to-peak distance defined between adjacent pleats of the interleaved pleats when the cellular drape is moved to the extended position. For example, in one embodiment, the length may be selected to be significantly longer than conventional spacers (e.g., greater than about five inches, such as approximately seven inches) to provide the desired maximum peak-to-peak distance, which may, in turn, allow for the desired amount of fullness or cross-wise depth to be achieved when the drape is moved to the extended position.

In one embodiment, each spacer is configured to be positioned within an interior of the rail, such as within the interior cavity of the rail. Additionally, in one embodiment, each spacer is engaged between an adjacent pair of carriers of the plurality of carrier assemblies. For instance, in one embodiment, each spacer is non-slidably engaged with a first carrier of each adjacent pair of carriers at the spacer's first end and is slidably engaged with a second carrier of each adjacent pair of carriers between the spacer's first and second ends to allow for relative movement between said first and second carriers along the lateral direction of said rail.

In alternative embodiments, each spacer is configured to be positioned outside of the rail. For example, in one embodiment, each spacer is installed relative to the cellular drape at various laterally spaced locations, such as between adjacent pleats of the cellular drape. Specifically, in one embodiment, the spacers may be configured to be coupled across the rear pleats of the cellular drape along the drape's top end. In another embodiment, the spacers may be configured to wrap around the rear pleats across the rear face of the cellular drape.

Moreover, in one embodiment, the carrier of each carrier assembly is configured to be mounted within a rearward facing slot of the rail. In another embodiment, the carrier of each carrier assembly is configured to be mounted within a downward facing slot of the rail. In one embodiment, the downward facing slot may be recessed relative to a front wall of the rail to allow all or a significant portion of each carrier assembly to be hidden or obscured from view as the associated covering assembly is being viewed from the front side of the assembly. By mounting each carrier within the rearward facing slot of the rail or by recessing the slot relative to the front wall of the rail, all or a significant portion of each carrier assembly may be hidden or obscured from view as the associated covering assembly is being viewed from the assembly's front side. As a result, the covering assembly may provide a more aesthetically pleasing look for consumers.

In one embodiment, the carrier of each carrier assembly includes a base portion configured to be slidably mounted within the mounting slot of the rail and a spacer portion extending outwardly from or disposed relative to the base portion such that the spacer position is located with the interior cavity of the rail.

In one embodiment, the rail defines opposed upper and lower tracks along opposite vertical sides of the rearwardly facing mounting slot. In such an embodiment, the base portion of the carrier includes an upper track post that is slidable within the upper track and a lower track post that is slidable within the lower track. Moreover, in one embodiment, the spacer portion is cantilevered off of the base portion as it extends into the interior cavity of the rail.

In another embodiment, the rail includes first and second track walls extending along opposed sides of the downwardly facing mounting slot. In such an embodiment, the base portion of the carrier includes track flanges that are slidable along the track walls to provide a contact interface between the carrier and the rail.

Additionally, in one embodiment, the drape connector includes a top connector portion coupled to the carrier and a bottom connector portion extending from the top connector portion. In one embodiment, the drape connector is configured to be coupled to the cellular drape at an attachment interface defined by the bottom connector portion.

In one embodiment, at least a portion of the attachment interface defined by the bottom connector portion is positioned vertically above the bottom side of the rail along the rear side of the rail. Accordingly, the attachment interface may be at least partially hidden or obscured from view when the associated covering assembly is being viewed from the front side of the assembly.

Moreover, in one embodiment, the attachment interface is defined by the bottom connector portion of the drape connector along a connection plane. In one embodiment, the connection plane is oriented generally perpendicular to the lateral direction and generally parallel to the cross-wise direction when the cellular drape is moved to the extended position. Such an orientation may, for example, allow the cellular drape to take on a full, open cellular configuration when in the extended position. For instance, the orientation of the connection plane may facilitate expanding the cellular structures to their fully open position.

In one embodiment, the drape connector is configured to be coupled indirectly to the cellular drape via an associated drape clip of each carrier assembly. In such an embodiment, the drape clip is configured to be coupled to the drape connector along at least a portion of the attachment interface. Additionally, in one embodiment, a top end of the drape clip is positioned vertically above the bottom side of the rail at the attachment interface, thereby allowing at least the top end of the drape clip to be positioned along the rear side of the rail and obscured from view.

In one embodiment, the top connector portion of the drape connector is pivotably coupled to the carrier about a vertically oriented pivot axis. For example, in one embodiment, the carrier defines a mounting channel along the rear side of the rail, with the top connector portion being supported within the mounting channel for pivotable movement relative to the carrier about the vertically oriented pivot axis. In another embodiment, the carrier defines a pivot opening for pivotably coupling the connector to the carrier about a vertically oriented pivot axis.

In another aspect, the present disclosure is directed to a mounting system for mounting a vertical cellular drape relative to an architectural structure. In one embodiment, the mounting system includes a rail and a plurality of carrier assemblies configured to support the cellular drape relative to the rail. Each carrier assembly includes a carrier movably coupled to the rail and a drape connector configured to be coupled between the carrier and the cellular drape. The carriers are movable relative to the rail along the length of the rail to allow the carrier assemblies to vertically support the cellular drape as it is moved relative to the architectural structure between an extended position and a retracted position.

In one embodiment, the rail extends in a lateral direction between a first end and a second end and in a vertical direction between a top side and an opposed bottom side. The rail also extends in a cross-wise direction between a front side configured to generally face the same direction as a front face of the cellular drape and a rear side opposite the front side. The rail further defines a mounting slot hidden from direct view, such as a rearward facing slot along the rear side of the rail or a downward facing slot along the bottom side of the rail, that extends laterally between the first and second ends of the rail. In one embodiment, the carrier of each carrier assembly may be movably mounted within the slot of the rail.

By mounting each carrier within the mounting slot of the rail, all or a significant portion of each carrier assembly may be hidden or obscured from view as the associated covering assembly is being viewed from the assembly's front, room-facing side. As a result, since all or a portion of each carrier assembly is not readily viewable, the covering assembly may provide a more aesthetically pleasing look for consumers.

In one embodiment, the drape connector of each carrier assembly includes a top connector portion coupled to the carrier and a bottom connector portion extending from the top connector portion. In one embodiment, the drape connector is configured to be coupled to the cellular drape at an attachment interface defined by the bottom connector portion of the drape connector. Additionally, in one embodiment, the attachment interface may be at least partially hidden or obscured from view when the associated covering assembly is being viewed from the assembly's front, room-facing side. For instance, at least a portion of the attachment interface defined by the bottom connector portion of the drape connector is positioned vertically above the bottom side of the rail along the rail's rear side to obscure such portion from view.

In one embodiment, the drape connector is configured to be coupled indirectly to the cellular drape via an associated drape clip of each carrier assembly. In such an embodiment, the drape clip is configured to be coupled to the drape connector along at least a portion of the attachment interface. Additionally, in one embodiment, at least a portion of the drape clip is configured to be positioned along the rear side of the rail and, thus, obscured from view. For instance, in one embodiment, a top end of the drape clip is positioned vertically above the bottom side of the rail at the attachment interface, thereby obscuring at least the top end of the drape clip from view.

Further, in one embodiment, the attachment interface is defined by the bottom connector portion of the drape connector along a connection plane. In one embodiment, the connection plane is oriented generally perpendicular to the lateral direction and generally parallel to the cross-wise direction when the cellular drape is moved to the extended position.

In one embodiment, the top connector portion of the drape connector is pivotably coupled to the carrier about a vertically oriented pivot axis. For example, in one embodiment, the carrier defines a mounting channel along the rear side of the rail, with the top connector portion being supported within the mounting channel for pivotable movement relative to the carrier about the vertically oriented pivot axis. In another embodiment, the carrier defines a pivot opening for pivotably coupling the connector to the carrier about a vertically oriented pivot axis.

Moreover, in one embodiment, the disclosed mounting system does not incorporate an active pivoting or tilting system. As a result, pivoting of the drape connector relative to the carrier may occur passively or freely as the cellular drape is being moved between the extended and retracted positions. In one embodiment, the drape connector may be configured to freely pivot relative to the carrier about a predetermined range of movement, such as predetermined angular range of movement. As will be described below, the lack of an active pivot system may also allow for the size of the carrier assemblies of the mounting system to be reduced, thereby providing for a more compact assembly that allows the lateral profile or width of the drape to be minimized when in the retracted position.

Additionally, in one embodiment, the carrier of each carrier assembly includes a base portion configured to be slidably mounted within a mounting slot in the rail. In one embodiment, the rail defines opposed upper and lower tracks along opposite vertical sides of a rearwardly facing mounting slit. In such an embodiment, the base portion of the carrier includes an upper track post that is slidable within the upper track and a lower track post that is slidable within the lower track. In another embodiment, the rail includes first and second track walls extending along opposed sides of the downwardly facing mounting slot. In such an embodiment, the base portion of the carrier includes track flanges that are slidable along the track walls to provide a contact interface between the carrier and the rail.

Moreover, in one embodiment, the carrier of each carrier assembly includes a spacer portion extending outwardly from or otherwise positioned relative to the base portion such that the spacer portion is disposed within the interior cavity of the rail. In one embodiment, the spacer portion is cantilevered off of the base portion as it extends into the interior cavity of the rail.

Additionally, in one embodiment, the mounting system includes a plurality of spacers positioned within the interior cavity. In one embodiment, each spacer is engaged between an adjacent pair of carriers of the plurality of carrier assemblies to allow for relative movement between the adjacent carriers along the lateral direction of the rail.

In alternative embodiments, the mounting system includes a plurality of external spacers positioned outside of the rail. For example, in one embodiment, the mounting system includes a plurality of spacers installed relative to the cellular drape at various laterally spaced locations, such as between adjacent features of the drape along the drape's rear side.

In one embodiment, the rail defines an outer profile that is arcuate-shaped across at least the front side of the rail. As a result, when viewed from its front side, the rail appears to have a circular cross-sectional shape. For example, the rail may appear to be shaped like a conventional drape rod from the rail's front side.

Additionally, in one embodiment, the outer profile of the rail includes a recessed profile section positioned vertically below the rearward facing mounting slot. The recessed profile section at least partially defines a recessed area that is recessed relative to another section of the outer profile of the rail. Moreover, in one embodiment, the drape connector is configured to at least partially extend around the outer profile of the rail from the rear side of the rail towards the bottom side of the rail such that the bottom connector portion of the drape connector is at least partially received or extends within the recessed area associated with the recessed profile section.

In one embodiment, the drape connector further includes a base support member extending vertically between the top and bottom connector portions along the rear side of the rail. In one embodiment, the bottom connector portion of the drape connector extends outwardly from the base support member in the cross-wise direction towards the front side of the rail such that at least a front corner of the bottom connector portion is positioned within the recessed area associated with the recessed profile section. In such an embodiment, the front corner of the bottom connector portion is positioned vertically above the bottom side of the rail.

It should be appreciated that, given the various advantages associated with application of the present disclosure to vertical cellular drapes, the present disclosure will generally be described herein with reference to using the disclosed mounting system in association with a vertical cellular drape. However, one of ordinary skill in the art should also appreciate that aspects of the disclosed mounting system may also be applied for use with other vertical drapes, including non-cellular drapes.

It should also be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one embodiment can be used separately, or with another embodiment to yield a still further embodiment. Thus, it is intended that the present disclosure covers such modifications and variations as come within the scope of the appended claims and their equivalents.

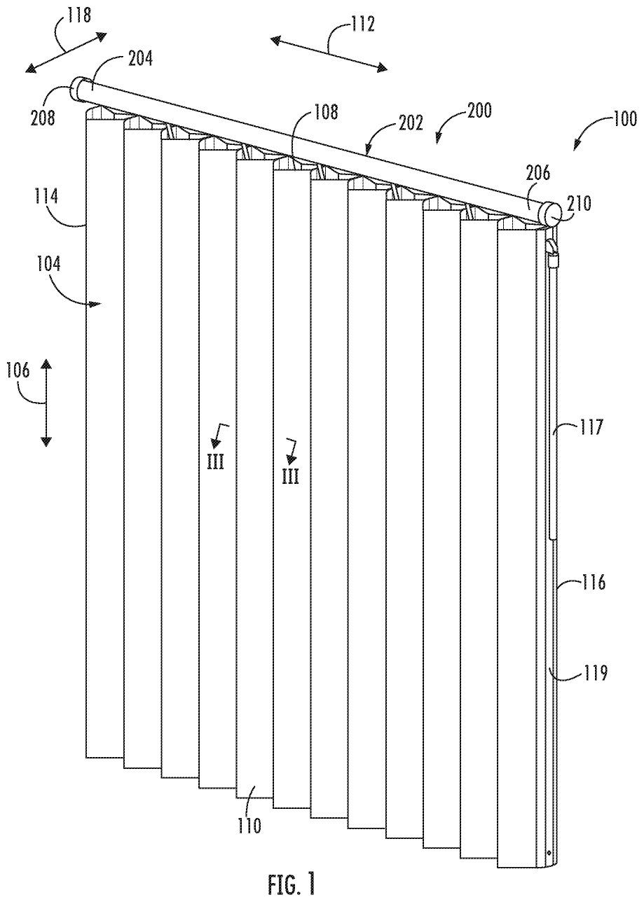

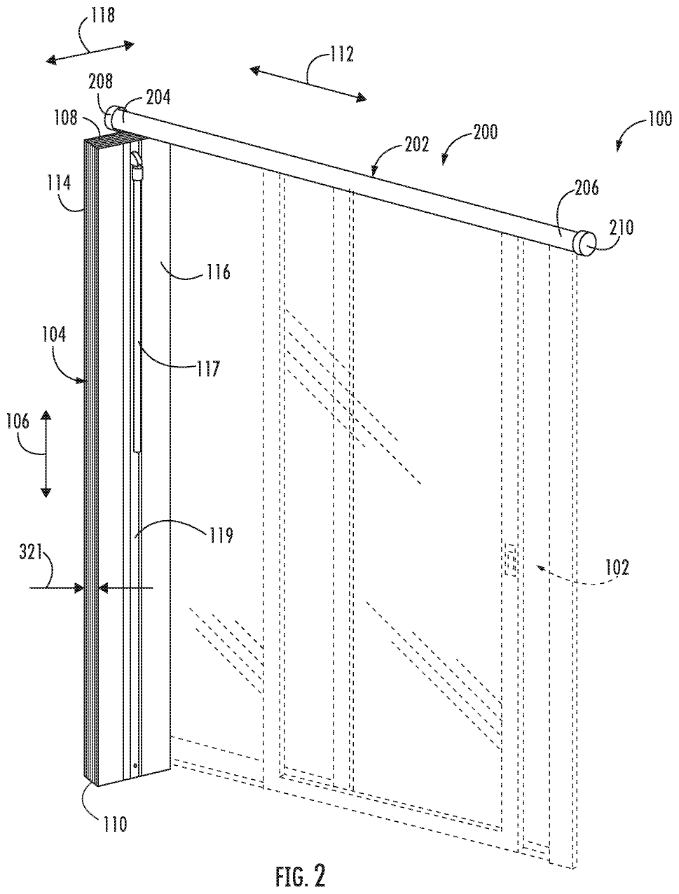

Referring now to FIGS. 1 and 2, one embodiment of a covering assembly 100 for covering an architectural structure (e.g., indicated by dashed lines 102 in FIG. 2) is illustrated in accordance with aspects of the present disclosure. In general, the covering assembly 100 includes a vertical cellular drape 104 and an associated mounting system 200 for mounting the cellular drape 104 relative to an architectural structure. In several embodiments, the covering assembly 100 is configured to be installed relative to a window, door, or other architectural structure as may be desired. However, it should also be understood that the covering assembly 100 is not limited in its particular use as a covering for a window or door, and may be used in any application as a partition, shade, and/or the like, relative to and/or within any type of architectural structure.

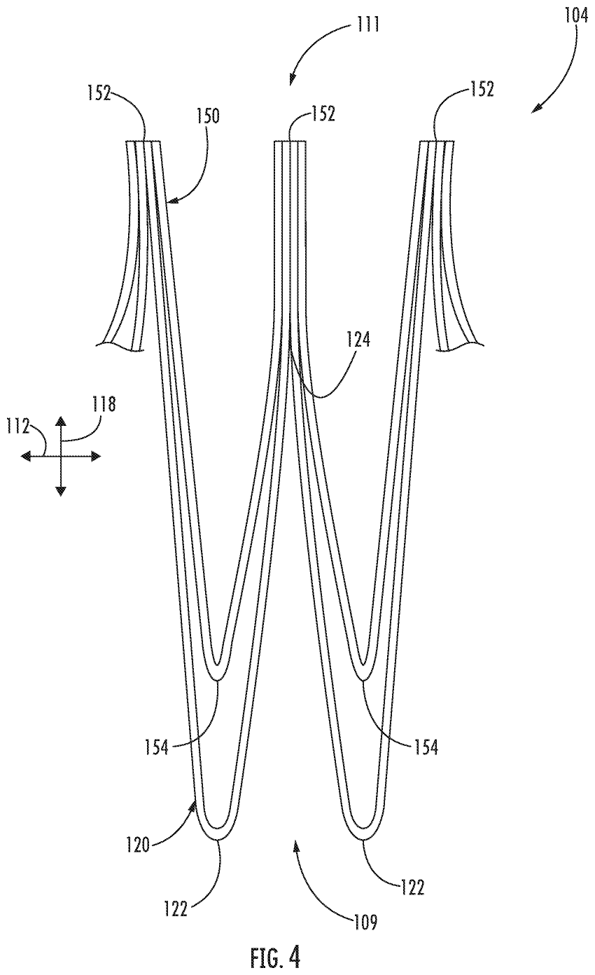

As shown in the illustrated embodiment, when suspended from the mounting system 200 relative to an architectural structure 102, the cellular drape 104 is moveable horizontally or laterally between an extended position (FIG. 1) and a retracted position (FIG. 2). When extended, the cellular drape 104 is configured to extend across and at least partially cover the adjacent architectural structure 102. For example, in one embodiment, the cellular drape 104 is configured to extend in a heightwise or vertical direction of the covering assembly 100 (indicated by arrow 106 shown in FIGS. 1 and 2) between a top end 108 and a bottom end 110 and in a horizontal or lateral direction of the covering assembly 100 (indicated by arrow 112 in FIGS. 1 and 2) between a first lateral end 114 and a second lateral end 116. Additionally, when retracted, the cellular drape 104 is generally configured to be collapsed in the lateral direction 112 to allow the drape 104 to be positioned along one side of the adjacent architectural structure 102, thereby exposing at least a portion of the architectural structure 102. For example, as will be described below with reference to FIG. 4, when moved towards the retracted position, the cellular drape 104 is collapsed into a folded or accordion-style configuration having a substantially flattened cellular profile, thereby allowing the drape 104 to take on a very compact lateral profile. In such an embodiment, as will be described below, one or more components of the mounting system 200 may be sized or adapted to accommodate such a compact lateral profile for the drape 104 when at the retracted position.

As shown in FIGS. 1 and 2, the mounting system 200 generally includes a rail 202 configured to be installed relative to the adjacent architectural structure 102 (FIG. 2), such as at a location at or adjacent to the top of the architectural structure 102. In general, the rail 202 is configured as an elongated support member extending longitudinally in the lateral direction 112 of the covering assembly 100 between a first rail end 204 and a second rail end 206. Additionally, as shown in the illustrated embodiment, endcaps are installed at the opposed ends 204, 206 of the rail 202, such as by installing a first endcap 208 at the first rail end 204 and a second endcap 210 at the second rail end 206. As will be described in greater detail below, the rail 202 is configured to be provided in operative association with a plurality of carriers and related components for supporting the cellular drape 104 relative to the rail 202 in a manner that allows the drape 104 to be moved between the extended and retracted positions. For example, the associated carriers may be slidably mounted to a portion of the rail 202 to allow the carriers to slide or otherwise move relative to the rail in the lateral direction 112 between the rail's first and second ends 204, 206. In such an embodiment, by coupling the carriers to the cellular drape 104 at spaced apart locations along the lateral width of the drape 104, the drape 104 may be slid or otherwise moved relative to the rail 202 between the retracted and extended positions. As will be described below, in one embodiment, the carriers may be slidably mounted within a mounting slot of the rail 202 (e.g., a rearward facing slot of the rail 202), thereby allowing the carriers and/or one or more additional components of the mounting system 200 to be at least partially obscured or hidden from view as the covering assembly 100 is being viewed from along the assembly's front side.

Additionally, the covering assembly 100 may include a control system to facilitate moving the cellular drape 104 between the extended and retracted positions. For example, as shown in the illustrated embodiment, the covering assembly 100 includes an operating wand 117 positioned at one of the lateral ends of the cellular drape 104 (e.g., the second lateral end 116). In such an embodiment, a user of the covering assembly 100 may pull/push the wand 117 to move the cellular drape 104 relative to the rail 202 between the extended and retracted positions. Moreover, in one embodiment, the operating wand 117 may be coupled to a spine or stabilizer 119 extending vertically along the adjacent lateral side on which the wand 117 is installed between the top and bottom ends 108, 110 of the drape 104. In general, the vertical stabilizer 119 may correspond to a rigid support member configured to provide structural support to the cellular drape 104 along the drape's lateral side and to also allow the opening/closing force applied to the wand 117 by the user to be transmitted along the height of the drape 104 to permit the drape 104 to be effectively and efficiently moved between the extended and retracted positions, as desired. As will be described below, the vertical stabilizer 119 may also be coupled to one of the carriers of the mounting system 200 (e.g., an end carrier) to further facilitate movement of the cellular drape 104 between the extended and retracted positions by allowing the opening/closing force applied to the wand 117 to be transmitted to the carrier, thereby resulting in movement of the carrier in the lateral direction 112 between the opposed ends 204, 206 of the rail 202.

It should be appreciated that, although not shown, a similar control system (e.g., a second operating wand) may also be provided in operative association with the other lateral side of the drape 104. In such instance, a similar vertical stabilizer may, for example, be installed along such lateral side of the drape 104 in association with the second control system.

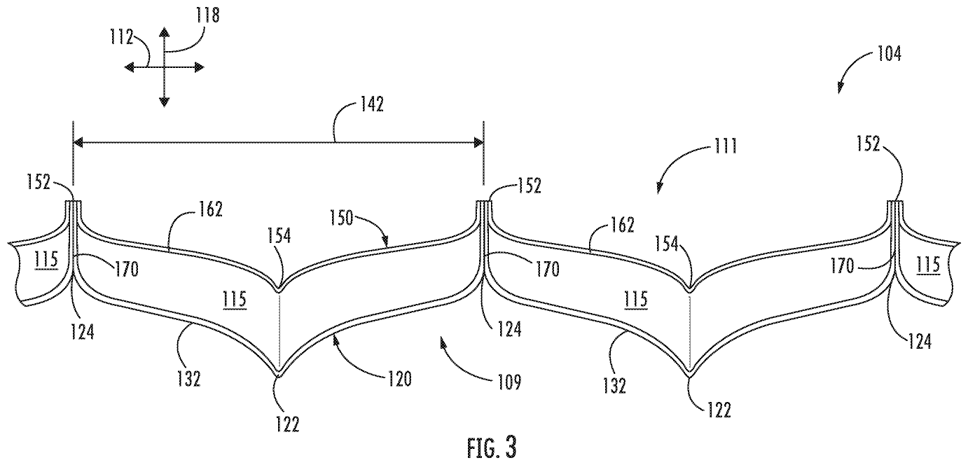

As indicated above, the disclosed mounting system 200 is generally configured to support a drape, such as the vertical cellular drape 104 shown in FIGS. 1 and 2, relative to an architectural structure. In this regard, an example configuration of one embodiment of a vertical cellular drape that may be advantageously supported by the disclosed mounting system 200 will generally be described below with reference to FIGS. 3 and 4. However, one of ordinary skill in the art should readily appreciate that the mounting system 200 may also be utilized to support drapes having any other suitable configuration, including any other suitable cellular and/or non-cellular drape configuration.

Referring now to FIGS. 3 and 4, cross-sectional views of one exemplary configuration for the cellular drape 104 of the covering assembly 100 described above with reference to FIGS. 1 and 2 are illustrated in accordance with aspects of the present disclosure. Specifically, FIG. 3 illustrates a cross-sectional view of a portion of the drape 104 shown in FIG. 1 taken about line (i.e., when the drape 104 is disposed at the extended position). Additionally, FIG. 4 illustrates a cross-sectional view of the portion of the drape 104 shown in FIG. 3 moved to a partially collapsed or retracted position, particularly illustrating the folded or accordion-style configuration of the drape 104. It should be appreciated that, as the drape 104 is further collapsed or retracted from the position shown in FIG. 4, the drape 104 may be moved into a more flattened state. However, it should be appreciated that, when the cellular drape 104* is moved to the fully retracted position, the drape 104* need not necessarily be fully compressed or collapsed.

As shown, the cellular drape 104 includes a pair of drape panels, such as a first or front drape panel 120 and a second or rear drape panel 150. In the embodiment illustrated in FIGS. 3 and 4, the front drape panel 120 is generally configured to define a front side or face 109 of the cellular drape 104 (e.g., between the opposed lateral ends 114, 116 and opposed top and bottom ends 108, 110 of the drape 104 along the exposed or outer face of the front drape panel 120). Similarly, in the illustrated embodiment, the rear drape panel 150 is generally configured to define a rear side or face 111 of the cellular drape 104 (e.g., between the opposed lateral ends 114, 116 and opposed top and bottom ends 108, 110 of the drape 104 along the exposed or outer face of the rear drape panel 150). As shown, when the cellular drape 104 is moved to the extended position, portions of the front and rear drape panels 120, 150 are configured to be spaced apart from each other in a cross-wise direction of the covering assembly 100 (e.g., as indicated by arrow 118 in FIG. 3) so that a plurality of vertically oriented internal cells 115 are defined between the drape panels 120, 150.

It should be appreciated that the terms “front” and rear” are generally used herein simply to distinguish the opposite sides or faces of components, features, and/or structure of the present disclosure, such as opposite sides of the disclosed cellular drape and/or components thereof and/or opposite sides of the disclosed mounting system and/or components thereof. Thus, one of ordinary skill in the art should readily appreciate that the front face 109 of the cellular drape 104 may correspond to either the side of the cellular drape 104 designed to face towards the interior of the room within which the drape 104 is installed or the side of the cellular drape 104 designed to face away from the interior of such room. However, for purposes of description, the front face 109 will be described herein as the side of the cellular drape 104 facing towards the interior of the room within which the drape 104 is installed, with the rear face 111 of the drape 104 facing towards the adjacent architectural structure 102.

It should also be appreciated that directional references are generally used herein simply for identification purposes to facilitate describing the present disclosure. However, in general, the vertical, lateral, and cross-wise directions 106, 112, 118 of the cellular drape 104 may be considered as defining a three-dimensional coordinate system. For example, in one embodiment, the vertical direction 106 of the covering assembly 100 is perpendicular to both the lateral and cross-wise directions 112, 118 of the assembly 100. Similarly, in one embodiment, the lateral direction 112 of the covering assembly is perpendicular to the cross-wise direction 118 of the assembly 100.

In several embodiments, the drape panels 120, 150 have a pleated configuration so that each drape panel 120, 150 includes a plurality of vertically oriented pleats (e.g., permanently set creases or folds) extending vertically between the top and bottom ends 108, 110 of the cellular drape 104. For example, as particularly shown in FIG. 3, the front drape panel 120 includes alternating, vertically extending front pleat peaks 122 and front pleat valleys 124 spaced apart across the front face 109 of the cellular drape 104 in the lateral direction 112. Additionally, the rear drape panel 150 includes alternating, vertically extending rear pleat peaks 152 and rear pleat valleys 154 spaced apart across the rear face 111 of the cellular drape 104 in the lateral direction 112. It should be appreciated that, as described herein, the pleat peaks and valleys 122, 124, 152, 154 are defined relative to the outwardly-facing or exposed sides of the drape panels 120, 150. Specifically, the front pleat peaks 122 and front pleat valleys 124 are defined relative to the outwardly-facing or exposed side of the front drape panel 120 (i.e., the front face 109) such that the front pleat peaks 122 generally extend away from the rear drape panel 150 and the front pleat valleys 124 generally extend towards the rear drape panel 150 when viewing the front face 109 of the cellular drape 104. Similarly, the rear pleat peaks 152 and rear pleat valleys 154 are defined relative to the outwardly-facing or exposed side of the rear drape panel 150 (i.e., the rear face 111) such that the rear pleat peaks 152 generally extend away from the front drape panel 120 and the rear pleat valleys 154 generally extend towards the front drape panel 120 when viewing the rear face 111 of the cellular drape 104.

In several embodiments, the pleat peaks and valleys 122, 124 defined by the front drape panel 120 across the front face 109 of the cellular drape 104 are interleaved relative to the pleat peaks and valleys 152, 154 defined by the rear drape panel 150 across the rear face 111 of the cellular drape 104. Specifically, as shown in FIG. 3, the pleat peaks and valleys 122, 124, 152, 154 are provided in an alternating configuration across the front and rear faces 109, 111 of the cellular drape 104. For example, in the illustrated embodiment, each front pleat peak 122 is substantially aligned with a corresponding rear pleat valley 154 in the cross-wise direction 118 of the cellular drape 104 while each front pleat valley 124 is substantially aligned with a corresponding rear pleat peak 152 in the cross-wise direction 118 of the cellular drape 104. Alternatively, the corresponding pleat peaks 122, 152 and valleys 124, 154 may be slightly offset from each other in the cross-wise direction 118.

It should be appreciated that the interleaved pleat configuration described herein may facilitate folding or stacking of the front and rear drape panels 120, 150 relative to each other when the cellular drape 104 is moved to the retracted position. For instance, as shown in FIG. 4, given the interleaved pleat configuration, each pair of corresponding front pleat peaks 122 and rear pleat valleys 154 and each pair of corresponding front pleat valleys 124 and rear pleat peaks 152 is configured to take on a nesting positional relationship relative to one another (e.g., each pleat valley 124, 154 may be nested relative to each corresponding pleat peak 152, 122) when the cellular drape 104 is moved towards the retracted position to allow the drape 104 to take on the folded or accordion-style configuration. Such a configuration allows for the drape 104 to define a very compact lateral profile when in the retracted position. For example, as shown in FIG. 2, the cellular drape 104 is configured to take on a substantially flat profile in the lateral direction 112 of the covering assembly 100 when in the retracted position so to define a desired minimal lateral width 321 (FIG. 2). In such an embodiment, as will be described below, a lateral dimension(s) of one or more components of the disclosed mounting system 200 may be selected to facilitate such collapsing of the drape 104 down to the desired lateral width 321 as the drape 104 is moved from the extended position to the retracted position.

It should also be appreciated that, in one embodiment, each drape panel 120, 150 may be formed as a continuous panel or sheet of material. Alternatively, each drape panel may be formed from separate strips or webs of material. For instance, in the embodiment shown in FIG. 3, the front drape panel 120 is formed from separate, vertical extending front webs 132 coupled end-to-end across the width of the panel 120 so that each front web 132 defines one of the front pleat peaks 122 of the front drape panel 120 and is coupled to neighboring front webs 132 at the adjacent front pleat valleys 124. Similarly, the rear drape panel 150 is formed from separate, vertical extending rear webs 162 coupled end-to-end across the width of the panel 150 so that each rear web 162 defines one of the rear pleat peaks 152 of the rear drape panel 150 and is coupled to neighboring rear webs 162 at the adjacent rear pleat valleys 154.

Additionally, in several embodiments, the cellular drape 104 includes a plurality of vertically extending tabs or ribs 170 spaced apart from one another along the lateral direction 112 of the covering assembly 100, with each inner cell 115 of the cellular drape 104 being defined laterally between neighboring or adjacent ribs 170. In one embodiment, each rib 170 may be formed by a portion(s) of the front drape panel 120 and/or the rear drape panel 150 extending in the cross-wise direction 118 of the covering assembly 100 between a corresponding pair of peaks/valleys of the cellular drape 104, such as between each front pleat peak 122 and each rear pleat valley 154. In such an embodiment, the front and rear drape panels 120, 150 may, for example, be coupled to one another at or adjacent to the location of each rib 170. Alternatively, when each rib 170 is formed by only a portion(s) of one of the drape panels 120, 150, the rib 170 may be configured to extend in the cross-wise direction 118 of the covering assembly 100 between each corresponding pair of peaks/valleys without being coupled to the other drape panel. In such an embodiment, it may be desirable for the cellular drape 104 to include headers (not shown) coupled between the front and rear drape panels 120, 150 at the top end 108 thereof (e.g., within each inner cell 115) to serve as the primary attachment structure for coupling the front drape panel 120 to the rear drape panel 150. As such, each drape panel 120, 150 may be suspended from the headers without being coupled to the other drape panel along the remainder of the panel's vertical height. For instance, the front and rear drape panels 120, 150 may be configured to simply hang from the headers adjacent to each other without having any other connection between the drape panels vertically below the headers.

It should be appreciated that, in embodiments in which the cellular drape 104 is configured to include headers, each header may, for example, correspond to a strip(s) of material coupled between the front and rear drape panels 120, 150 at the top end 108 of the drape 104. For instance, in one embodiment, each header may be formed from a material that is more stiff or rigid than the material used to form the drape panels 120, 150. As such, the headers may assist in forming and maintaining the shape of the internal cells 115 defined between the drape panels 120, 150 when the cellular drape 104 is moved to the extended position. For example, due to the properties of the material used to form the headers, each header may be configured to spring or expand outwardly to push or force adjacent portions of the drape panels 120, 150 apart from each other as the cellular drape 104 is extended to facilitate formation of the internal cells 115 between the drape panels 120, 150.

It should also be appreciated that, in one embodiment, the degree of extension of the cellular drape 104 may be defined or represented by a peak-to-peak distance defined between adjacent pleat peaks 122 of the front drape panel 120 or adjacent pleat peaks 152 of the rear drape panel 150. For instance, as shown in FIG. 3, a peak-to-peak distance 142 is defined between each pair of adjacent rear pleat peaks 152. In such an embodiment, the peak-to-peak distance 142 generally decreases as the cellular drape 104 is collapsed or retracted towards the retracted position and generally increases as the cellular drape 104 is expanded or extended towards the extended position. Additionally, in one embodiment, the cellular drape 104 is configured to define a maximum peak-to-peak distance 142 when in the extended position to allow the internal cells 115 to take on or otherwise define a desired angular orientation, thereby allowing the cellular drape 104 to be provided with a predetermined amount of fullness or cross-wise depth. In such an embodiment, the maximum peak-to-peak distance may be defined or set using components, features, and/or structure of the disclosed mounting system. For instance, as will be described below, the mounting system may include spacers that serve to set the maximum peak-to-peak distance for the drape when it is moved to the fully extended position, such as by carefully selecting the lengths of the spacers to allow the drape to achieve a desired maximum peak-to-peak distance at the fully extended position. The desired maximum peak-to-peak distance may generally be selected, for example, to allow the desired amount of fullness or cross-wise depth to be achieved when the drape 104 is moved to the extended position.

As indicated above, it should be appreciated that the configuration of the vertical cellular drape 104 described above and shown in FIGS. 1-4 is provided only to place the present disclosure in an exemplary field of use. Thus, it should be appreciated that the present disclosure may be readily adaptable to any manner of cellular drape configuration.

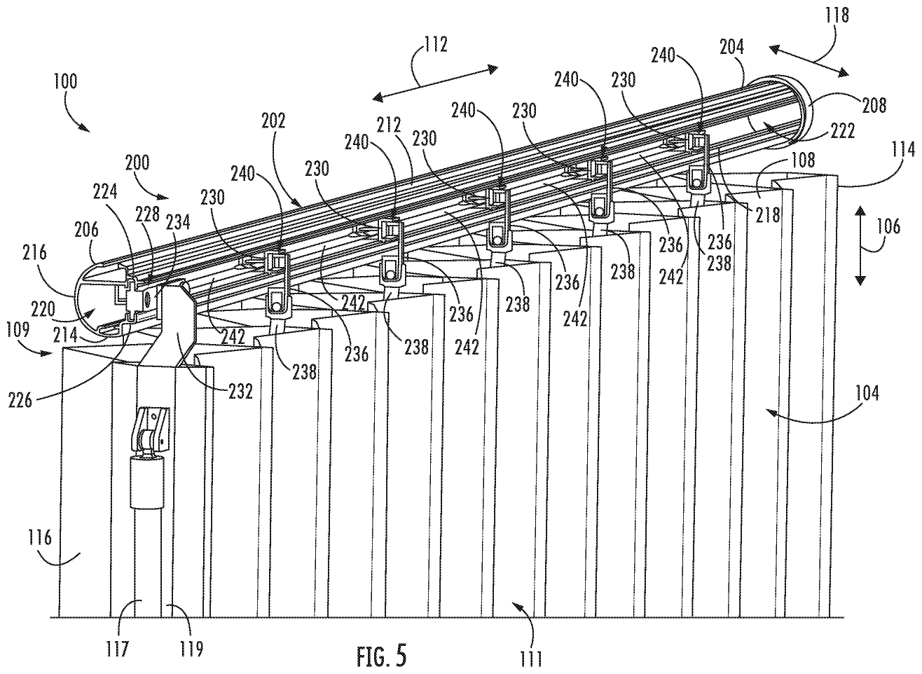

Referring now to FIG. 5, a rear perspective view of a portion of the covering assembly 100 shown in FIG. 1 is illustrated in accordance with aspects of the present disclosure, particularly illustrating various components, features, and/or structure of one exemplary embodiment of a mounting system 200 for supporting a vertical cellular drape relative to an architectural structure. As indicated above, the mounting system 200 includes a rail 202 extending lengthwise or laterally between opposed, first and second rail ends 204, 206. In addition, the mounting system 200 may also include corresponding first and second endcaps 208, 210 configured to be installed at the first and second rail ends 204, 206, respectively. As shown in FIG. 5, for purposes of illustration, the second endcap 210 has been removed from the rail 202 to allow aspects of the mounting system 200 to be viewed from such end 206 of the rail 202.

As shown in the illustrated embodiment, the rail 202 of the mounting system 200 extends in the vertical direction 106 of the covering assembly 100 between a top side 212 and a bottom side 214. The rail 202 also extends in the cross-wise direction 118 of the covering assembly 100 between a front side 216 configured to face in the same direction as the front face 109 of the cellular drape 104 and a rear side 218 configured to face in the opposite direction (i.e., in the same direction as the rear face 111 of the cellular drape 104). In one embodiment, the rail 202 may be hollow. For example, as shown in FIG. 5, the rail 202 defines an interior cavity 220 extending between the rail's opposed lateral ends 204, 206. Additionally, as shown in FIG. 5, the rail 202 defines a rearward facing mounting slot 222 along the rear side 218 of the rail 202 that extends lengthwise or laterally between the opposed lateral ends 204, 206 of the rail 202. As such, the rear mounting slot 222 is open along the rear side 218 of the rail 202 and provides access to the rail's interior cavity 220. Moreover, in several embodiments, the rail 202 includes one or more tracks extending along the length of the mounting slot 222. For instance, as will be described in greater detail below, in one embodiment, the rail 202 includes an upper track 224 positioned at the upper end of the slot 222 and a lower track 226 positioned at the lower end of the slot 222, with both tracks 224, 226 extending lengthwise or laterally between the opposed lateral ends 204, 206 of the rail 202.

As indicated above, the mounting system 200 also includes a plurality of carriers configured to be slidably or movably supported by the rail 202 to allow the carriers to be slid or moved along the length of the rail 202 between the rail's first and second ends 204, 206. Specifically, in the illustrated embodiment, the carriers are configured to be slidably or movably supported within the rear mounting slot 222 between the upper and lower tracks 224, 226 of the rail 202 such that each carrier may be slid or moved between the opposed ends 204, 206 of the rail 202. In one embodiment, each carrier is, in turn, coupled to a portion of the cellular drape 104 (e.g., via one or more additional components of the mounting system 200). Thus, as the cellular drape 104 is moved between the extended and retracted positions (e.g., via use of the operating wand 117), the carriers may be configured to move or slide within the slot 222 along the rear side 218 of the rail 202 with corresponding movement of the drape 104 to support the drape 104 relative to the rail 202. As will be described below, such rearward mounting of the carriers and associated components of the mounting system 200 may allow such component(s) to be obscured or hidden from view as the drape 104 is being viewed from its front side.

As shown in FIG. 5, in several embodiments, the mounting system 200 includes at least one end carrier 228 and one or more intermediate carriers 230 configured to be supported within the rear mounting slot 222 for slidable movement along the length of the rail 202. Each end carrier 228 is configured to be coupled to the cellular drape 104 at one of the drape's lateral ends 114, 116. For example, in the illustrated embodiment, the mounting system 200 includes a single end carrier 228 coupled to the cellular drape 104 at the drape's second lateral end 116. However, in other embodiments, the end carrier 228 may be coupled to the opposite side of the drape 104 or the mounting system may include a pair of end carriers 228, with each end carrier 228 being coupled to one of the lateral ends 114, 116 of the drape 104. As shown in FIG. 5, in one embodiment, the end carrier 228 is coupled to the adjacent lateral end 116 of the cellular drape 104 via a support bracket 232 that is coupled to a rear face 234 of the end carrier 228 and extends vertically downwardly therefrom. Specifically, in one embodiment, the support bracket 232 is coupled to the end carrier 228 at the bracket's top end and to the adjacent vertical stabilizer 119 of the cellular drape 104 at the bracket's bottom end, which, in turn, extends vertically along the length of the adjacent lateral end 116 of the drape 104. As such, when a user of the disclosed covering assembly 100 grasps the operating wand 117 to pull/push the drape 104 between the extended and retracted positions, the opening/closing force applied to the wand 117 is transmitted to the end carrier 228 (e.g., via the vertical stabilizer 119 and the associated support bracket 232) to cause the end carrier 228 to be moved relative to the rail 202 in the desired direction.

It should be appreciated that, in instances in which the cellular drape 104 is configured to be moved to the retracted position along either lateral side of the adjacent architectural structure 102, it may be desirable to include end carriers 228 coupled to each lateral end 114, 116 of the drape 104. In such embodiments, the cellular drape 104 may, for example, include a vertical stabilizer 119 extending vertically along each of the drape's lateral ends 114, 116 (and, optionally, an associated wand 117 coupled to the stabilizer 119), in which case each end carrier 228 may be coupled to the adjacent vertical stabilizer 119 via an associated support bracket 232.

Additionally, as shown in FIG. 5, the intermediate carriers 230 are configured to be coupled to portions of the cellular drape 104 at or adjacent to the top end 108 of the drape 104 that are spaced apart from one another between the drape's first and second lateral ends 114, 116 such that the intermediate carriers 230 function to support the drape 104 relative to the rail 202 at such spaced apart locations along the drape's width. As will be described in greater detail below, in several embodiments, each intermediate carrier 230 may be coupled to a portion of the cellular drape 104 via an associated drape connector 236 that is configured to wrap around at least a portion of the outer profile of the rail 202 along the rail's rear side 218. For example, as shown in FIG. 5, a drape connector 236 is coupled to each intermediate carrier 230 along the rear side 218 of the rail 202 and may extend downwardly therefrom to a location at or adjacent to the rail's bottom side 214. The drape connector 236 may then be coupled directly or indirectly to the adjacent portion of the cellular drape 104. For example, as shown the illustrated embodiment, each drape connector 236 is coupled to the cellular drape 104 via an associated drape clip 238. As such, via the connection provided by the drape connector 236 (and the optional drape clip 238), each intermediate carrier 230 is configured to be coupled to a separate portion of the cellular drape 104 at or adjacent to the top end 108 of the drape 104 to allow the intermediate carriers 230 to slide or move relative to the rail 202 along the mounting slot 222 as such portions of the cellular drape 104 are moved to adjust the configuration of the drape 104 between the extended and retracted positions. For purposes of discussion, each individual set of intermediate carriers 230, drape connectors 236, and drape clips 238 will be described herein as forming a carrier assembly 240. However, it should be appreciated that, in other embodiments, each carrier assembly 240 may only include a sub-combination of such components, such as by configuring each carrier assembly 240 to only include an intermediate carrier 230 and the associated drape connector 236 (e.g., when the connector 236 is configured to be coupled directly to the drape 104).

It should be appreciated that the carrier assemblies 240 may be coupled to any suitable portion of the cellular drape 104 disposed at or adjacent to the drape's top end 108 that allows the drape 104 to be vertically supported relative to the rail 202 by such assemblies 240. For example, in one embodiment, each carrier assembly 240 may be coupled to one of the cross-wise extending ribs 170 (FIG. 3) of the vertical cellular drape 104, such as by coupling a carrier assembly 240 to a top portion of every cross-wise rib 170 or every other cross-wise rib 170 along the lateral width of the drape 104. Alternatively, when headers are installed at or adjacent to the top end 108 of the cellular drape 104 (e.g., as separate strips of material disposed at the top end of each inner cell 115 (FIG. 3)), a carrier assembly 240 may, for example, be coupled to every header or every other header along the lateral width of the drape 104.

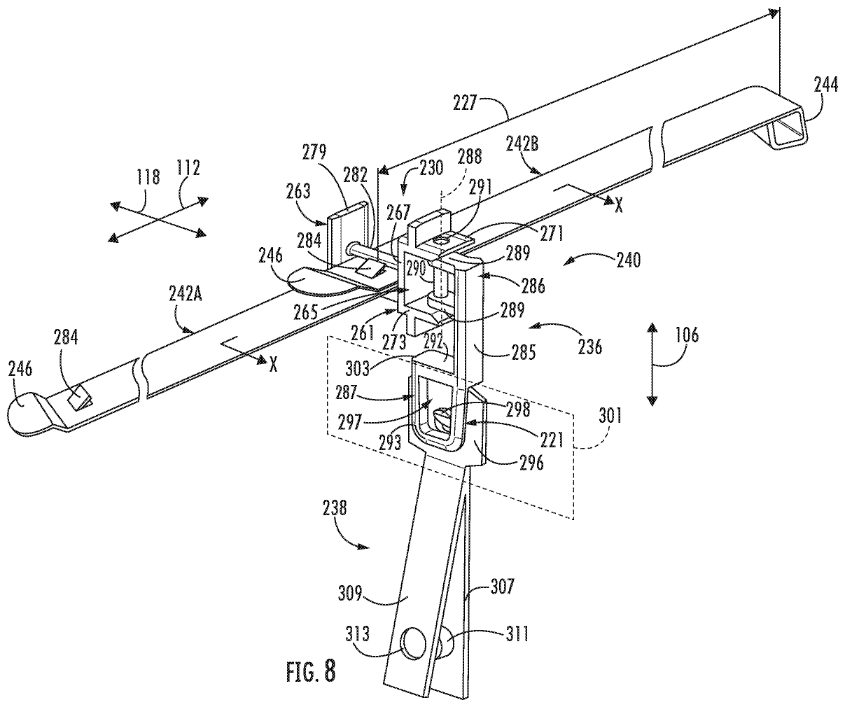

Moreover, as shown in FIG. 5, the disclosed mounting system 200 also includes a plurality of sliders or spacers 242 (referred to herein simply as “spacers” for the sake of convenience without intent to limit) configured to extend lengthwise within the interior cavity 220 of the rail 202, with each spacer 242 being coupled or engaged between an adjacent pair of carriers 228, 230. Specifically, in several embodiments, each spacer 242 may be configured to be fixedly or non-slidably coupled to or engaged with one of the carriers of a given pair of adjacent carriers and slidably coupled to or engaged with the other carrier of the pair of adjacent carriers. For instance, as will be described in greater detail below, each spacer 242 extends lengthwise between a first end 244 (FIG. 8) and an opposed second end 246 (FIG. 8), with the first end 244 configured to be non-slidably coupled to or engaged with one of the carriers 228, 230 such that the spacer 242 extends outwardly therefrom. In such an embodiment, the spacer 242 is also configured to be slidably coupled to or engaged within a portion of an adjacent carrier between the spacer's first and second ends 244, 246 to allow for relative movement between the adjacent pair of carriers as the drape 104 is moved between the extended and retracted positions. In addition, the spacers 242 may also be used to set the maximum lateral spacing between adjacent carriers 228, 230 when the drape is moved to the extended position, which may, in turn, set the maximum peak-to-peak distance for the cellular drape 104. For example, as will be described below, a length of each spacer 242 may be selected such that each carrier is configured to be moved relative to an adjacent carrier along the length of the associated spacer 242 until an engagement tab or stop 284 (FIG. 8) provided proximal to the second end 246 of the spacer 242 contacts or otherwise engages the adjacent carrier. In this regard, the spacers 242 may serve to couple all of the carriers 228, 230 together, thereby allowing the carriers 228, 230 to be pulled sequentially across the length of the rail 202 as the cellular drape 104 is being moved between the extended and retracted positions.

For instance, in the example view of FIG. 5, the spacer 242 located closest to the second lateral end 206 of the rail 202 is slidably coupled to or engaged with the end carrier 228 and non-slidably coupled to or engaged with the immediately adjacent intermediate carrier 230. Similarly, the next adjacent spacer 242 is slidably coupled to or engaged with the intermediate carrier 230 disposed immediately adjacent to the end carrier 228 and non-slidably coupled to or engaged with the next adjacent intermediate carrier 230 and so on across the lateral width of the covering assembly 100 such that, from the perspective of the view shown in FIG. 5, each spacer 242 is slidably coupled to or engaged with the leftmost carrier of a given pair of adjacent carriers and non-slidably coupled to or engaged with the rightmost carrier of such pair of adjacent carriers. In such an embodiment, when moving the vertical drape 104 from the retracted position (e.g., with all of the carriers 228, 230 being positioned at or adjacent to the first lateral end 204 of the rail 202) to the extended position, the end carrier 228 is initially moved or slid along the mounting slot 222 towards the second end 206 of the rail 202 until the end carrier 228 contacts or otherwise engages the stop 284 (FIG. 8) of the adjacent spacer 242, at which point further movement of the end carrier 228 towards the second end 206 of the rail 202 results in the adjacent intermediate carrier 230 being similarly pulled towards the second end 206 of the rail 202 via the intermediate carrier's connection to the end carrier 228 by the associated spacer 242. In this way, due to the connection provided by the spacers 242, the end carrier 228 sequentially pulls the intermediate carriers 230 across the rail 202 to move the cellular drape 104 from the retracted position to the extended position. Moreover, as will be described below, the slidable connection provided by the spacers 242 may also allow the carriers 228, 230 to stack up laterally against one another when the cellular drape 104 is moved to the retracted position.

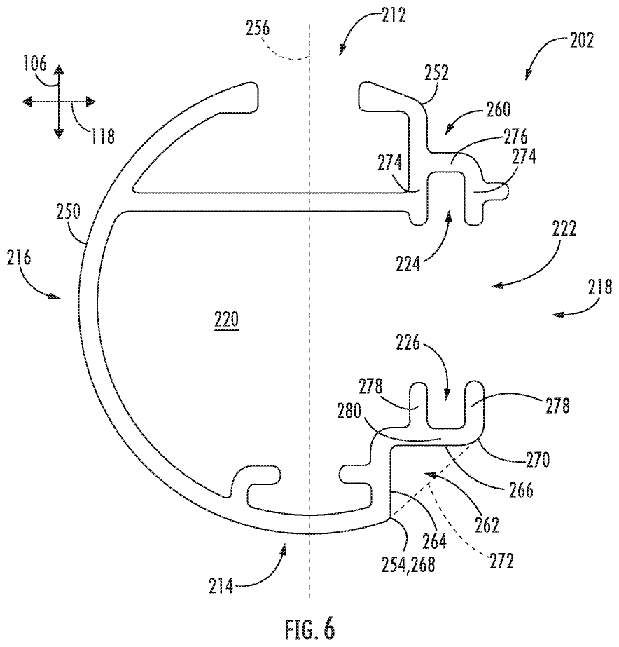

Referring now to FIG. 6, an end view of a portion of the mounting system 200 described above is illustrated in accordance with aspects of the present disclosure. Specifically, FIG. 6 illustrates an end view of the second end 206 of the rail 202 shown in FIG. 5, with the carriers 228, 230 and other related components removed for purposes of illustration.

In general, the rail 202 may be configured to define an outer profile having a substantially circular cross-sectional shape. For instance, as particularly shown in FIG. 6, the outer profile of the rail 202 is semi-circular or arcuate-shaped across a substantial portion of the rail's outer perimeter, such as across an arcuate-shaped profile section 250 of the outer profile extending from a first circumferential end 252 to a second circumferential end 254, with the first circumferential end 252 being located rearward of a vertical centerline 256 of the rail 202 along the top side 212 of the rail 202 and the second circumferential end 254 being located rearward of the vertical centerline 256 along the bottom side 214 of the rail 202. Thus, the arcuate-shaped profile section 250 generally extends across the front side 216 of the rail 202 to locations rearward of the vertical centerline 256 along the top and bottom sides 212, 214 of the rail 202. As such, when viewed from the front side of the covering assembly 100 (e.g., the view shown in FIGS. 1 and 2), the outer profile of the rail 202 generally appears to have a circular overall profile shape. For example, in one embodiment, the rail 202 may generally appear to be configured similar to a conventional drape or curtain rod from the front side of the covering assembly 100.

Additionally, in several embodiments, the rail 202 is configured in a manner so as to accommodate one or more components of each carrier assembly 240 along the rear side 218 of the rail 202 (i.e., rearward of the centerline 256), thereby allowing such component(s) to be obscured or hidden from view when the covering assembly 100 is viewed along the assembly's front side. For example, as indicated above, the rear mounting slot 222 of the rail 202 is configured to allow the carriers 228, 230 to be slidably mounted along the rear side 218 of the rail 202. In addition, as will be described below, at least a portion of each drape connector 236 (and, optionally, at least a portion of each drape clip 238) may be supported relative to the associated carrier 228, 230 along the rear side 218 of the rail 202 so as to be at least partially obscured or hidden from view, such as by configuring all or a substantial portion of each drape connector 236 to be position vertically above the bottom side 214 of rail 202 along the rail's rear side 218.

In one embodiment, the rail 202 defines a non-arcuate profile along the rail's rear side 218, such as across the section of the outer profile of the rail 202 extending along the rear side 218 of the rail 202 between the first and second circumferential ends 252, 254 of the arcuate-shaped profile section 250. For instance, as shown in FIG. 6, the rail 202 defines a stepped outer profile as it extends from the first circumferential end 252 of the arcuate-shaped profile section 250 to the location of the rear mounting slot 222 such that the rail 202 defines an upper recessed profile section 260 vertically above the rear mounting slot 222. Similarly, the rail 202 defines a stepped outer profile as it extends vertically from the second circumferential end 254 of the arcuate-shaped profile section 250 to the location of the rear mounting slot 222 such that the rail 202 defines a lower recessed profile section 262 vertically below the rear mounting slot 222.

Such upper and lower recessed profile sections 260, 262 may generally correspond to portions of the outer profile of the rail 202 that are recessed relative to otherwise circular profile shape defined by the arcuate-shaped profile section 250. For example, as shown in FIG. 6, the lower recessed profile section 262 is defined by a first recessed outer surface 264 (e.g., a vertically oriented surface) extending from a bottom edge 268 of the lower recessed profile section 262 (e.g., as defined at the second circumferential end 254 of the arcuate-shaped profile section 250) towards the top side 212 of the rail 202, and a second recessed outer surface 266 (e.g., a horizontally oriented surface) extending from the first recessed outer surface 264 towards the rear side 218 of the rail 202 to a rear edge 270 of the lower recessed profile section 262. In such an embodiment, the lower recessed profile section 262 of the rail 202 least partially defines a recessed area relative to the otherwise circular profile shape of the rail 202, such as by defining a recessed area encompassed by the open area defined between the recessed outer surfaces 264, 266 of the lower recessed profile section 262 and a reference line 272 extending directly between the bottom and rear edges 268, 270 of the lower recessed profile section 262. As will be described below, the lower recessed profile section 262 of the rail 202 may be configured to accommodate a portion of each adjacent carrier assembly 240 (e.g., a complementary portion of each drape connector 236) to allow a connection point or attachment interface defined between the carrier assemblies 240 and the cellular drape 104 to be located at a desired position relative to the rail 202. For example, in one embodiment, at least a portion of the attachment interface may be positioned vertically above the bottom side 214 of rail 202 along the rail's rear side 218, thereby obscuring such portion(s) of the mounting system 200 from view.

Additionally, as indicated above and as illustrated in FIG. 6, the rail 202 defines upper and lower tracks 224, 226 relative to the rear mounting slot 222 for slidably mounting the carriers 228, 230 relative to the rail 202. Specifically, as shown in FIG. 6, the upper track 224 is generally defined at the top end of the mounting slot 222 and is configured as an open-ended channel, with the open end of the track 224 facing downwards towards the opposed lower track 226. For example, the upper track 224 may have an upside-down, “U-shaped” profile having first and side sides defined by opposed upper track sidewalls 274 and a top side defined by an upper track wall 276. Additionally, the lower track 226 is generally defined at the bottom end of the mounting slot 222 and is configured as an open-ended channel, with the open end of the track 226 facing upwards towards the opposed upper track 224. For example, the lower track 226 may have a “U-shaped” profile having first and side sides defined by opposed lower track sidewalls 278 and a bottom side defined by a lower track wall 280. As shown in FIG. 8, in the illustrated embodiment, the lower track wall 280 defines both the bottom side of the lower track 226 (e.g., along the top end of the wall 280) and the second recessed outer surface 266 of the lower recessed profile section 262 of the rail 202 (e.g., along the bottom end of the wall 280).

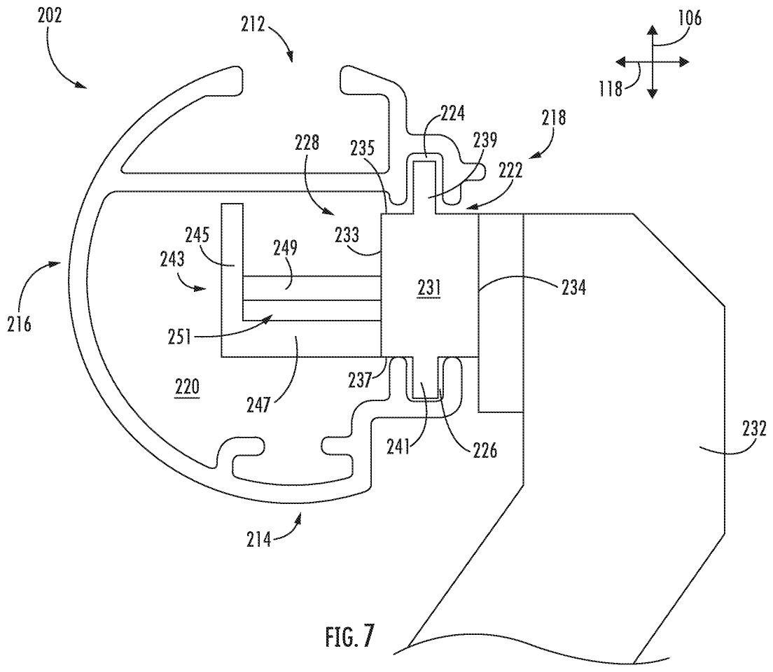

Referring now to FIG. 7, another end view of a portion the mounting system 200 described above is illustrated in accordance with aspects of the present disclosure. Specifically, FIG. 7 illustrates an end view of the second end 206 of the rail 202 shown in FIG. 5, particularly illustrating the end carrier 228 and a portion of the associated support bracket 232 installed relative to the rail 202.

As shown in FIG. 7, the end carrier 228 generally includes a base portion 231 configured to be slidably coupled to the rail 202 within the rear mounting slot 222. Specifically, in several embodiments, the base portion 231 of the end carrier 228 may generally define a substantially rectangular profile including opposed front and rear faces 233, 234, with the front face 233 facing the front side 216 of the rail 202 and the rear face 234 being positioned along the rear side 218 of the rail 202. As indicated above, a top end of the support bracket 232 may be coupled to the end carrier 228 at the bracket's rear face 234, with the opposed end of the support bracket 232 being coupled to the adjacent vertical stabilizer 119 (FIG. 5).

Additionally, as shown in FIG. 7, the base portion 231 of the end carrier 228 is generally configured to extend vertically within the rear mounting slot 222 between an upper face 235 and a lower face 237, with the upper face 235 being positioned vertically below the open end of the upper track 224 of the rail 202 and the lower face 237 being positioned vertically above the open end of the lower track 226. Moreover, in several embodiments, the end carrier 228 includes one or more track engagement features or structure extending outwardly from the upper and lower faces 235, 237 of the base portion 231 for engagement with and/or receipt within the upper and lower tracks 224, 226 of the rail 202. In one embodiment, the track engagement features or structure may be configured to improve the stability of the end carrier 228 within the rear mounting slot 222 by serving as an anti-rotation feature for the mounting system 200 (e.g., by preventing rotation of the end carrier 228 relative to the rail 202 about one or more axes). Such stabilization of the end carrier 228 within the rear mounting slot 222 may, for example, allow for the lateral dimension or thickness of the end carrier 228 to be reduced or minimized, which may, in turn, permit the overall lateral width 321 (FIG. 2) of the cellular drape 104 to be reduced when the drape 104 is moved to the retracted position.

For example, as shown in FIG. 7, an upper track post 239 extends outwardly from the upper face 235 of the base portion 231 such that the upper track post 239 extends within the upper track 224. Similarly, a lower track post 241 extends outwardly from the lower face 237 of the base portion 231 such that the lower track post 241 extends within the lower track 226. As such, the upper and lower track posts 239, 241 function both to stabilize the end carrier 228 within the rear mounting slot 222 and to slidably support the end carrier 228 relative to the tracks 224, 226 as the end carrier 228 is moved along the length of the rail 202.

Additionally, the end carrier 228 also includes a spacer portion 243 configured to extend outwardly from the base portion 231 into the interior cavity 220 of the rail 202 when the carrier 228 is installed relative to the rail 202. Specifically, as shown in FIG. 7, the spacer portion 243 is cantilevered off of the front face 233 of the base portion 231 such that the spacer portion 243 extends into the rail's interior cavity 220. In general, the spacer portion 243 of the end carrier 228 may be configured to allow the end carrier 228 to be coupled to or engaged with one or more of the spacers 242 of the mounting system 200. For example, as shown in FIG. 7, the spacer portion 243 has an “L-shaped” profile including a front wall 245 spaced apart from the base portion 231 of the end carrier 228 and a bottom wall 247 extending between the front wall 245 and the front face 233 of the base portion 231. Additionally, in the illustrated embodiment, the spacer portion 243 also includes an engagement bar 249 extending between the front wall 245 of the spacer portion 243 and the front face 233 of the base portion 231 at a location spaced apart from the bottom wall 247. For instance, as shown in FIG. 7, the engagement bar 249 is spaced apart vertically above the bottom wall 247 of the spacer portion 243 such that a spacer gap 251 is defined vertically between the engagement bar 249 and the bottom wall 247. In such an embodiment, as will be described below, a given spacer 242 of the mounting system 200 may be configured to be slidably received within or otherwise extend through the spacer gap 251 to slidably couple the spacer 242 to the end carrier 228, thereby allowing the relative lateral spacing between the end carrier 228 and the immediately adjacent intermediate carrier 230 to vary as the cellular drape 104 is being moved between the extended and retracted positions. Additionally, as will be described below, a corresponding engagement tab or stop 284 (FIG. 8) of the associated spacer 242 may be configured to engage or otherwise contact the engagement bar 249 when the end carrier 228 is moved away from the immediately adjacent intermediate carrier 230 as the cellular drape 104 is being moved to the extended position to allow the end carrier 228 to pull the adjacent intermediate carrier 230 along the length of the rail 202.

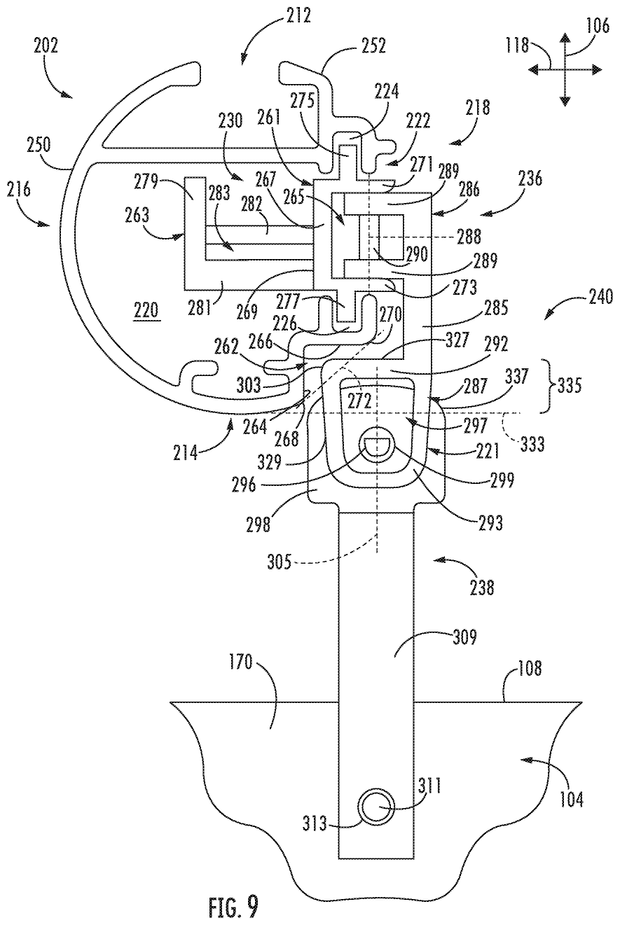

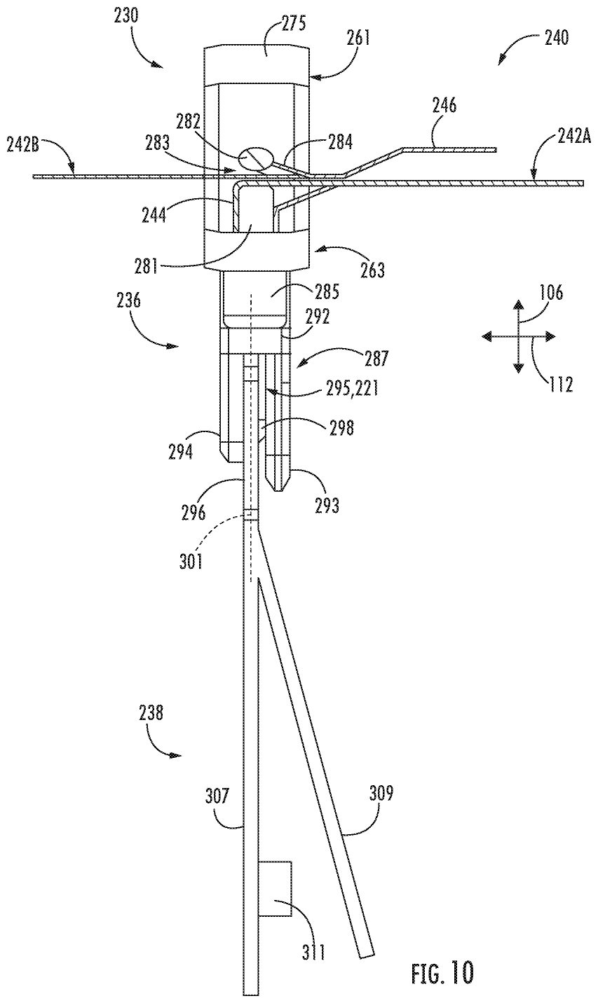

Referring now to FIGS. 8-10, differing views of one embodiment of one of the carrier assemblies 240 of the mounting system 200 described above with reference to FIG. 5 is illustrated in accordance with aspects of the present disclosure. Specifically, FIG. 8 illustrates a perspective view of the carrier assembly 240 with adjacent first and second spacers 242A, 242B of the disclosed mounting system 200 being installed relative thereto and FIG. 9 illustrates a side view of the carrier assembly 240 as installed relative the rail 202. Additionally, FIG. 10 illustrates a cross-sectional view of the carrier assembly 240 shown in FIG. 8 take about line X-X.

As indicated above, in several embodiments, each carrier assembly 240 includes an intermediate carrier 230, a drape connector 236, and a drape clip 238 of the disclosed mounting system 200, with the drape connector 236 and drape clip 238 being coupled between the intermediate carrier 230 and a portion of the cellular drape 104 to allow the drape 104 to be supported by the carrier assembly 240 relative to the rail 202. As shown in the illustrated embodiment, similar to the end carrier 228 described above with reference to FIG. 7, the intermediate carrier 230 includes a base portion 261 and a spacer portion 263, with the base portion 261 configured to be slidably coupled to the rail 202 within the rear mounting slot 222 and the spacer portion 263 configured to extend outwardly from the base portion 261 to allow one or more spacers 242 of the mounting system 200 to be coupled thereto and/or engaged therewith within the interior of the rail 202. However, unlike the generally rectangular shaped base portion 231 of the end carrier 228 described above, the base portion 261 of the intermediate carrier 230 generally defines a “C-shaped” profile forming a rearwardly facing mounting channel 265 for coupling a portion of the drape connector 236 to the carrier 230. Specifically, as shown in FIGS. 8 and 9, the base portion 261 includes a vertically extending base wall 267 defining a front face 269 (FIG. 9) of the base portion 261. In addition, the base portion 261 includes a top wall 271 and a bottom wall 273 extending rearwardly from the base wall 267, with the top and bottom walls 271, 273 being spaced vertically apart from one another such that the rearwardly facing mounting channel 265 is defined therebetween.

As particularly shown in FIG. 9, when the intermediate carrier 230 is installed relative to the rail 202, the top wall 271 of the base portion 261 is generally positioned vertically below the open end of the upper track 224 of the rail 202 while the bottom wall 273 is generally positioned vertically above the open end of the lower track 226. Additionally, similar to the end carrier 228 described above, the intermediate carrier 230 may also include one or more track engagement features or structure extending outwardly from the top and bottom walls 271, 273 of the base portion 261 for engagement with and/or receipt within the upper and lower tracks 224, 226 of the rail 202. In such an embodiment, the track engagement features or structure may be configured to improve the stability of the intermediate carrier 230 within the rear mounting slot 222 by serving as an anti-rotation feature for the mounting system 200 (e.g., by preventing rotation of the intermediate carrier 230 relative to the rail 202 about one or more axes). Such stabilization of the intermediate carrier 230 within the rear mounting slot 222 may, for example, allow for the lateral dimension or thickness of the intermediate carrier 230 to be reduced or minimized, which may, in turn, permit the overall lateral width 321 (FIG. 2) of the cellular drape 104 to be reduced when the drape 104 is moved to the retracted position.

As shown in FIG. 9, in one embodiment, an upper track post 275 extends outwardly from the top wall 271 of the base portion 261 such that the upper track post 275 extends within the upper track 224. Similarly, a lower track post 277 extends outwardly from the bottom wall 273 of the base portion 261 such that the lower track post 277 extends within the lower track 226. As such, the upper and lower track posts 275, 277 function both to stabilize the carrier 230 within the rear mounting slot 222 and to slidably support the carrier 230 relative to the tracks 224, 226 as the carrier 230 is moved along the length of the rail 202.

Moreover, as indicated above, the intermediate carrier 230 also includes a spacer portion 263 extending outwardly from the carrier's base portion 261 into the interior cavity 220 of the rail 202. Specifically, as shown in FIG. 9, the spacer portion 263 is cantilevered off of the front face 269 of the base portion 261 such that the spacer portion 263 extends into the rail's interior cavity 220. In general, the spacer portion 263 of the intermediate carrier 230 may be configured the same as or similar to the spacer portion 243 of the end carrier 228 described above with reference to FIG. 7. For example, as shown in FIG. 9, the spacer portion 263 has an “L-shaped” profile including a front wall 279 spaced apart from the base portion 261 of the intermediate carrier 230 and a bottom wall 281 extending between the front wall 279 and the front face 269 of the base portion 261. Additionally, the spacer portion 263 includes an engagement bar 282 extending between the front wall 279 of the spacer portion 263 and the front face 269 of the base portion 261 at a location spaced apart from the bottom wall 281. For instance, as shown in FIG. 9, the engagement bar 282 is spaced apart vertically above the bottom wall 281 of the spacer portion 263 such that a spacer gap 283 is defined vertically between the engagement bar 282 and the bottom wall 281. As such, a given spacer 242 of the mounting system 200 may be configured to be slidably received within or otherwise extend through the spacer gap 283 to slidably couple the spacer 242 to the intermediate carrier 230.

For example, in the views illustrated in FIGS. 8 and 10, the intermediate carrier 230 is shown as installed relative to a first spacer 242A and a second spacer 242B of the disclosed mounting system 200. Specifically, in the illustrated embodiment, the first spacer 242A is configured to be non-slidably coupled to or engaged with the intermediate carrier 230 whereas the second spacer 242B is configured to be slidably coupled to or engaged with the intermediate carrier 230. For example, as particularly shown in FIG. 10, a first end 244 of the first spacer 242A is coupled to or engaged with the bottom wall 281 of the spacer portion 263 of the intermediate carrier 230, such as by being wrapped around the bottom wall 281. In such an embodiment, the first spacer 242A is configured to be slidably coupled to or engaged with the spacer portion of an adjacent carrier between the spacer's first end 244 and its opposed second end 246, such as the spacer portion 243 of the end carrier 228 or the spacer portion 263 of another intermediate carrier 230. Similarly, as shown in FIGS. 8 and 10, the second spacer 242B is shown as extending through the spacer gap 283 (FIG. 10) defined by the spacer portion 263 of the intermediate carrier 230 to allow the carrier 230 to move relative to the spacer 242B between the spacer's second end 246 and its opposed first end 244 (which may, in turn, be configured to be coupled to the spacer portion of an adjacent carrier, such as the spacer portion 263 of an adjacent intermediate carrier 230). Additionally, as particularly shown in the illustrated embodiment, an engagement tab or stop 284 may be defined at or adjacent to the second end 246 of each spacer 242A, 242B. As such, when the carrier 230 is moved relative to the second spacer 242B, the stop 284 may prevent the carrier 230 and the spacer 242B from becoming decoupled from each other. For example, the intermediate carrier 230 may be moved relative to the spacer 242B towards the spacer's second end 246 until the engagement bar 282 of the carrier 230 contacts or otherwise engages against the stop 284 of the spacer 242B, thereby preventing further relative movement of the carrier 230 in such direction. In such an embodiment, a length 227 (FIG. 8) of each spacer 242A, 242B defined between the spacer's first end 244 and its engagement tab or stop 284 may be selected so as to set the desired range of relative travel between adjacent carriers, thereby, in turn, allowing the maximum peak-to-peak distance to be set for the cellular drape 104.

It should be appreciated that the specific length 227 (FIG. 8) selected for the spacers 242 may generally vary depending on the configuration of the covering assembly 100, as well as the desired maximum peak-to-peak distance for the cellular drape 104 (e.g., as selected to allow the desired amount of fullness or cross-wise depth to be achieved when the drape 104 is moved to the extended position). However, in a particular embodiment, the length 227 of each spacer 242 is equal to a length that is greater than 5 inches, such as greater than 5.5 inches, or greater than 6 inches, or greater than 6.5 inches, including any lengths defined within such range(s) in increments of 0.05 inches. Additionally, in another embodiment, the length 227 of each spacer 242 is equal to a length that is less than 8 inches, such as less than 7.5 inches, or less than 7 inches, or less than 6.5 inches, or less than 6 inches, including any lengths defined within such range(s) in increments of 0.05 inches. Moreover, in one embodiment, the length 227 of each spacer 242 may be greater than 5 inches and less than 8 inches, such as greater than 6 inches and less than 8 inches, or greater than 6.5 inches and less than 7.5 inches, or greater than 6.75 inches and less than 7.25 inches, including any lengths defined within such range(s) in increments of 0.05 inches. Such an increased spacer length is significantly greater than prior art spacers used with conventional mounting systems in association with conventional drapes.

It should also be appreciated that the above-described interaction and/or engagement between the intermediate carrier 230 and the associated spacers 242A, 242B may similarly apply to other intermediate carriers 230 of the disclosed mounting system 200. For example, the spacer portion 263 of each intermediate carrier 230 may have a first spacer non-slidably coupled thereto or engaged therewith (e.g., via the bottom wall 281 of the spacer portion 263) and a second spacer slidably coupled thereto or engaged therewith (e.g., via the spacer gap 283 of the spacer portion 263), with the first spacer being slidably coupled to or engaged with an adjacent carrier positioned on one side of the carrier along the lateral direction 112 of the covering assembly 100 and the second spacer being non-slidably coupled to or engaged with an adjacent carrier positioned on the opposed side of the carrier along the lateral direction 112 of the covering assembly 100. Similarly, it should be appreciated that, for any carrier configured to be coupled to one of the lateral ends 114, 116 of the drape 104 (e.g., the end carrier 228), the carrier may only be configured to be coupled to a single spacer 242 of the mounting system 200.

Referring still to FIGS. 8-10, as indicated above, the drape connector 236 of each carrier assembly 240 is generally configured to be coupled between the adjacent intermediate carrier 230 and the cellular drape 104 (e.g., via the associated drape clip 238) to support the drape 104 relative to the rail 202. As particularly shown in FIGS. 8 and 9, the drape connector 236 generally includes a base support member 285 extending between opposed top and bottom connector portions 286, 287 of the connector 236, with the top connector portion 286 configured to be coupled to the intermediate carrier 230 and the bottom connector portion 287 configured to be coupled to the associated drape clip 238 (or, in alternative embodiments, directly to the cellular drape 104). Specifically, in several embodiments, the top connector portion 286 (FIGS. 8 and 9) of the drape connector 236 is configured to be pivotably coupled to the base portion 261 of the intermediate carrier 230 to allow the drape connector 236 to pivot relative to the carrier 230 about a vertically oriented pivot axis 288 as the drape 104 is being moved between the extended and retracted positions. For example, as shown in FIGS. 8 and 9, the top connector portion 286 includes first and second upper connector members 289 extending outwardly from a top end of the base support member 285 (e.g., when assembled, in the cross-wise direction 118 towards the front side of the covering assembly 100) into the rearward facing mounting channel 265 defined by the base portion 261 of the intermediate carrier 230. Additionally, the top connector portion 286 includes a pivot post 290 extending between the upper connector members 289 and outwardly therefrom for receipt within corresponding pivot openings 291 (one of which is shown in FIG. 8) defined through the top and bottom walls 271, 273 of the base portion 261. As such, when top and bottom ends of the pivot post 290 are received within the corresponding pivot openings 291 defined in the top and bottom walls 271, 273 of the base portion 261, respectively, the drape connector 236 is configured to pivot or rotate about the pivot axis 288 extending vertically through the center of the pivot post 290 and/or the centers of the associated pivot openings 291. Such a pivotable connection between the drape connector 236 and the carrier 230 may allow the connecter 236 to pivot relative to the carrier 230, as necessary, as the cellular drape 104 is being moved between the extended and retracted positions. It should be appreciated that, given the absence of an active pivot system, such pivoting occurs passively or freely as the cellular drape 104 is being extended or retracted.

In general, the bottom connector portion 287 of the drape connector 236 may be configured to be coupled to the drape 104. Specifically, in several embodiments, the bottom connector portion 287 of the drape connector 236 is configured to define an attachment interface 221 for allowing the drape connector 236 to be coupled (e.g., either directly or indirectly) to the drape 104. For example, in the illustrated embodiment, the attachment interface 221 defined by the bottom connector portion 287 is configured to allow the drape clip 238 to be coupled directly thereto, thereby permitting the clip 238 (and, thus, the drape 104) to be suspended from the connector 236. Alternatively, the attachment interface 221 may be configured to allow the drape 104 to be suspended directly from the drape connector 236. Regardless, as will be described below, in one embodiment, at least a portion of the attachment interface 221 defined by the bottom connector portion 287 is configured to be disposed vertically above the bottom side 214 of the rail 202 along the rail's rear side 218, thereby obscuring or hiding at least a portion of the connection between the connector 236 and the drape 104 from view and also allowing such connection point to be raised relative to the rail 202 to minimize any gaps defined between the rail 202 and the top end 108 of the drape 104.

In the illustrated embodiment, the bottom connector portion 287 includes a base connector wall 292 extending outwardly from a bottom end of the base support member 285 in the same forward direction as the upper connector members 289 of the top connector portion 286 (e.g., when assembled, in the cross-wise direction 118 towards the front side of the covering assembly 100). Additionally, as particularly shown in FIG. 10, the bottom connector portion 287 includes first and second lower connector members 293, 294 extending vertically downwardly from the base connector wall 292, with the lower connector members 293, 294 generally defining the attachment interface 221 for coupling the bottom connector portion 287 to the drape clip 238. Specifically, in the illustrated embodiment, the lower connector members 293, 294 are spaced apart from each other so as to define a vertically oriented connector channel 295 (FIG. 10) therebetween for receiving a mounting tab 296 of the drape clip 238. In such an embodiment, the mounting tab 296 of the drape clip 238 may be configured to be coupled to the drape connector 236 across the attachment interface 221 defined along the connector channel 295 between the lower connector members 293, 294. For example, as shown in FIGS. 8 and 10, the first lower connector member 293 defines a connector opening 297 for at least partially receiving a connector hook 298 extending outwardly from the second lower connector member 294 across the connector channel 295 (FIG. 10). In such an embodiment, a corresponding hook opening 299 (FIG. 9) is defined in the mounting tab 296 of the drape clip 238 through which the hook 298 passes when the clip 238 is inserted between the lower connector members 293, 294 within the connector channel 295. Specifically, in one embodiment, the lower connector members 293, 294 may be pulled slightly apart to allow the mounting tab 296 of the drape clip 238 to be inserted within the channel 295 past the connector hook 298 until the hook 298 is aligned with and passes through the hook opening 299. The lower connector members 293, 294 may then be released to allow such members to spring back towards each other so that the connector hook 298 also passes through the opposed the connector opening 297 of the first lower connector member 293, thereby allowing the drape clip 238 to be retained relative to the drape connector 236.

It should be appreciated that, in one embodiment, the attachment interface 221 is configured to be defined by the bottom connector portion 287 of the drape connector 236 along a vertical connection plane (e.g., as indicated by lines 301 in FIGS. 8 and 10) that extends substantially perpendicular to the lateral direction 112 of the covering assembly 100 (e.g., perpendicular to the longitudinal direction of the rail 202 extending between the rail's opposed lateral ends 204, 206) and parallel to the cross-wise direction 118 of the covering assembly 100 (e.g., in the cross-wise direction 118 of the rail 202 extending between its front and rear sides 216, 218) when the cellular drape 104 is disposed at the extended position. For example, as shown in FIG. 10, the connection plane 301 is defined vertically along the center of the connector channel 295 of the bottom connector portion 287 and extends generally parallel to the attachment interface 221 defined by lower connector members 293, 294. As such, when the cellular drape 104 is moved to the extended position, the bottom connector portion 287 of the drape connector 236 generally extends outwardly from the base support member 285 of the drape connector 236 towards the front side 216 of the rail 202 along the connection plane 301 in a direction substantially perpendicular to the lateral direction 112 of the covering assembly 100 and substantially parallel to the cross-wise direction 118 of the covering assembly 100.

It should also be appreciated that, in other embodiments, the attachment interface 221 defined by the bottom connector portion 287 of the drape connector 236 may have any other suitable configuration that allows the drape clip 238 to be coupled to the drape connector 236. For instance, as opposed to including a pair of lower connector members 293, 294 defining a connector channel 295 therebetween for receiving the mounting tab 296 of the drape clip 238, the bottom connector portion 287 may simply include a single connector member defining an attachment interface across or along which the drape clip 238 is configured to be coupled, such as by using any suitable connection means, feature, and/or structure (e.g., a hook, post, clip, other fastener, and/or the like).

As indicated above, by configuring the disclosed mounting system 200 in accordance with aspects of the present disclosure, one or more components of each carrier assembly 240 are configured to be positioned along the rear side 218 of the rail 202 and, thus, obscured from view. For example, as shown in FIG. 9, given the positioning of the intermediate carrier 230 of each carrier assembly 240 within the rear mounting slot 222 of the rail 202, such carriers 230 are completely obscured or hidden from view when the covering assembly 100 is being viewed from the assembly's front side. Additionally, as shown in FIG. 9, a significant portion of the drape connector 236 of each carrier assembly 240 is positioned vertically above the bottom side 214 of the rail 202 (e.g., as indicated by a horizontal reference plane 333 shown in FIG. 9 that extends tangent to the bottom side 214 of the rail 202). For example, as shown in the illustrated embodiment, in addition to the entirety of the top connector portion 286 and the base support member 285 of the drape connector 236, a vertical section 335 of the bottom connector portion 287 of the drape connector 236 (along with the portion of the attachment interface 221 defined thereby) is positioned vertically above the bottom side 214 of the rail 202. As a result, a portion of the connection defined between the drape connector 236 and the drape clip 238 across the attachment interface 221 is obscured or hidden from view. Specifically, as shown in FIG. 9, when the drape clip 238 is coupled to the drape connector 236, a top end 337 of the drape clip 238 is configured to extend vertically above the bottom side 214 of the rail 202 along the adjacent portion of the attachment interface 221 defined by the bottom connector portion 287 of the drape connector 236.

Moreover, as particularly shown in FIG. 9, by configuring the drape connector 236 in accordance with aspects of the present disclosure, the connector 236 is configured to at least partially wrap around the outer profile of the rail 202 along the rail's rear side 218 towards the bottom side 214 of the rail 202 when the connector 236 is assembled onto an associated carrier 230 relative to the rail 202. Specifically, as shown in FIG. 9, the base support member 285 of the drape connector 236 is generally configured to extend vertically along the rear side 218 of the rail 202, with the top and bottom connector portions 286, 287 of the connector 236 extending outwardly from the base support member 285 in the direction of the front side 216 of the rail 202. Additionally, in accordance with aspects of the present disclosure, the lower connector portion 287 is configured to extend from the base support member 285 of the drape connector 236 such that it is at least partially located within the cut-out or recessed area defined by the lower recessed profile section 262 of the rail 202 (e.g., within the area defined between the rail and the reference line 272 shown in FIG. 9). Specifically, as shown in FIG. 9, the base connector wall 292 of the bottom connector portion 287 extends outwardly from the base support member 285 such that at least a front corner 303 of the bottom connector portion 287 is positioned within the recessed area defined by the lower recessed profile section 262, such as by configuring the front corner 303 of the bottom connector portion 287 to be located both forward of the rear edge 270 of the lower recessed profile section 262 (e.g., by being located closer to the front side 216 of the rail 202 than the rear edge 270 in the cross-wise direction 118) and vertically above the bottom edge 268 of the lower recessed profile section 262 (e.g., by being located closer to the top side 212 of the rail 202 than the bottom edge 268 in the vertical 106).

By configuring the drape connector 236 to at least partially wrap around the outer profile of the rail 202 as it extends from the rearward facing mounting slot 222 towards the bottom side 214 of the rail 202, the connection point between the drape connector 236 and the associated drape clip 238 (e.g., as defined along the attachment interface 221) is moved forward in the direction of the front side 216 of the rail 202. For example, as shown in FIG. 9, the cross-wise location of the connection point between the connector/clip and between the carrier assembly/drape (e.g., as indicated by dashed line 305) is positioned forward of both the rearward-most portion of the rail 202 and the base support member 285 of the drape connector 236. In addition, by configuring the bottom connector portion 287 to at least partially extends within the recessed area defined by the lower recessed profile section 262 of the rail 202, the attachment interface 221 defined between the connector/clip is allowed to be positioned further vertically upward relative to the bottom side 214 of the rail 202. As a result, the vertical gap defined between the bottom side 214 of the rail 202 and the top end 108 of the cellular drape 104 may be minimized.

Moreover, in several embodiments, the shape of the bottom connector portion 287 of the drape connector 236 at or adjacent to the connector's front corner 303 may be configured to be complementary to shape the lower recessed profile section 262 of the rail 202 to maximize the amount of the bottom connector portion 287 that extends within the recessed area defined by the lower recessed profile section 262 and/or to allow the bottom connector portion 287 to extend directly adjacent to one or both of the recessed outer surfaces 264, 266 of the lower recessed profile section 262. For example, as shown in FIG. 9, the bottom connector portion 287 includes both a horizontally oriented upper surface 327 (e.g., as defined by upper surface of the base connector wall 292 of the bottom connector portion 287) extending from the base support member 285 to the front corner 303 of the bottom connector portion 287 that is generally parallel to the second recessed outer surface 266 of the lower recessed profile section 262 and a vertically oriented side surface 329 (e.g., as defined by the side surface of the base connector wall 292 and/or the side surface(s) of one or both of the lower connector members 293, 294 of the bottom connector portion 287) extending vertically downwardly from the front corner 303 of the bottom connector portion 287 that is generally parallel to the first recessed outer surface 264 of the lower recessed profile section 262. In such an embodiment, the front corner 303 of the bottom connector portion 287 and the lower recessed profile section 262 may define complementary right angles.

Referring still to FIGS. 8-10, the drape clip 238 of each carrier assembly 240 is generally configured to be coupled between the drape connector 236 and the cellular drape 104 to allow the drape 104 to be supported relative to the rail 202. As indicated above, the drape clip 238 is configured to be coupled to the top end 108 of the cellular drape 104, such as by coupling the clip 238 to one or both of the drape panels 120, 150 or to a corresponding header installed relative to the drape panels 120, 150 at the top end 108 of the drape 104. For example, in the embodiment illustrated in both FIG. 5 and FIG. 9, the drape clip 238 is shown as being coupled to the cellular drape 104 at the location of one of the drape's divider walls or ribs 170. In such an embodiment, when the drape's ribs 170 are configured to be oriented generally in the cross-wise direction 118 of the covering assembly 100, the drape clip 238 is configured to be coupled to the drape 104 at an attachment interface defined along the same connection plane 301 as the attachment interface 221 defined between the drape connector 236 and the drape clip 238 such that the plane 301 forms a common connection plane across which the drape connector 236 is coupled to the cellular drape 104 when the drape 104 is located at the extended position (i.e., a common mounting plane extending in a direction substantially perpendicular to the lateral direction 112 of the covering assembly 100 and substantially parallel to the cross-wise direction 118 of the covering assembly 100).

As shown in FIGS. 8 and 10, the drape clip 238 includes first and second clip arms 307, 309 extending vertically from the mounting tab 296 for coupling the clip 238 to the cellular drape 104. Specifically, in the illustrated embodiment, the first clip arm 307 includes a clip post 311 configured to extend within a corresponding clip opening 313 defined in the second clip arm 309. In such an embodiment, when coupling the clip 238 to the cellular drape 104, the top end 108 of the drape 104 is configured to be positioned between the first and second clip arms 307, 309 to allow the clip post 311 to be inserted through a corresponding opening (not shown) defined in the drape 104 at or adjacent to the drape's top end 108. Once the clip post 311 is received through the opening defined in the drape 104, the clip post 311 may be inserted or snapped into the associated clip opening 313 defined through the second clip arm 309 to secure the clip 238 to the drape 104. However, it should be appreciated that, in alternative embodiments, the drape clip 238 may have any other suitable configuration that allows it to be coupled between the drape connector 236 and the cellular drape 104 to support the drape 104 relative to the rail 202.

It should be appreciated that, as indicated above, the cellular drape 104 may be configured to be coupled directly to the drape connector 236 as opposed to being coupled to the connector 236 indirectly via the drape clip 238. For example, in alternative embodiments, each carrier assembly 240 may simply include an intermediate carrier 230 and an associated drape connector 236, with the connector 236 being configured to be coupled directly between the carrier 230 and the cellular drape 104. In such an embodiment, the bottom connector portion 287 of the drape connector 236 may be configured to define a suitable attachment interface for coupling the connector 236 to the cellular drape 104 at or adjacent to the drape's top end 108. For example, the top end 108 of the cellular drape 104 may be configured to be coupled to the bottom connector portion 287 in a manner similar to that described above with reference to the drape clip 238, such as by inserting the top end 108 of the drape 104 within the connector channel 295 defined between the lower connector members 293, 294 until the connector hook 298 of the drape connector 236 extends within a corresponding opening (not shown) defined through the drape 104. However, it should be appreciated that, in alternative embodiments, the bottom connector portion 287 of the drape connector 236 may have any other suitable configuration that allows it to be coupled to the cellular drape 104 in a manner consistent with the disclosure provided herein.

Additionally, it should appreciated that, in several embodiments, the disclosed carrier assemblies 240 are generally configured to stack tightly against one another (i.e., in abutting engagement with one another) in the lateral direction 112 of the covering assembly 100 when the cellular drape 104 is moved to the retracted position, thereby allowing the overall lateral profile or width of the drape 104 to be minimized at such position. Specifically, as indicated above, the cellular drape 104 is configured to be collapsed into a folded or accordion-style configuration in the retracted position so that it is capable of taking on a substantially flat profile in the lateral direction 112 of the covering assembly 100 having a desired minimal lateral width 321 (FIG. 2). Accordingly, in one embodiment, to facilitate such collapsing of the cellular drape 104 into a folded or accordion-style configuration, the associated lateral profile or thickness of the stacked carrier assemblies 240 is configured to be minimized as much as possible. It should be appreciated that, when the cellular drape 104 takes on the folded or accordion-style configuration, the drape 104 need not necessarily be fully compressed or collapsed as the drape 104 is moved to the retracted position.

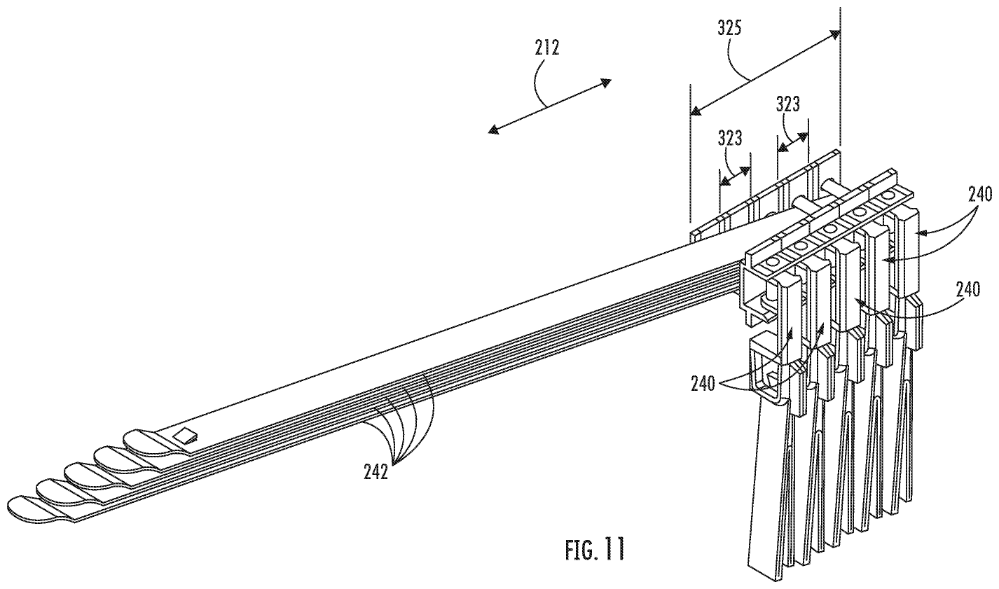

For example, FIG. 11 illustrates a perspective view of the stacked configuration that can be achieved with the disclosed carrier assemblies 240 when the cellular drape 104 is moved to the retracted position. As shown, the carrier assemblies 240 are configured to be stacked laterally in an abutting or side-by-side relationship, with the carrier 230 of each carrier assembly 240 being positioned directly adjacent to and/or contacting the carrier 230 of an adjacent assembly(ies) 240. In such an embodiment, a lateral thickness 323 of each carrier assembly 240 (which generally corresponds to the lateral thickness or width of each associated intermediate carrier 230) is selected such that, when the carrier assemblies 240 are stacked in the configuration shown in FIG. 11, an overall lateral thickness 325 of the assembly stack is generally less than or equal to the desired minimal lateral width 321 (FIG. 2) of the cellular drape 104 when in the retracted position. For example, in one embodiment, the lateral thickness 323 of each carrier assembly 240 may be minimized to achieve the smallest lateral stack thickness 325 possible.

It should be appreciated that, in general, the lateral thickness 323 selected for the carrier assemblies 240 may vary depending on the configuration of the covering assembly 100, as well as the desired minimal lateral width 321 (FIG. 2) for the cellular drape 104. However, in a particular embodiment, the lateral thickness 323 of each carrier assembly 240 is equal to a lateral distance that is less than one inch, such as less than 0.75 inches, or less than 0.50 inches, or less than 0.30 inches, including any thicknesses defined within such range(s) in increments of 0.02 inches. Additionally, in one embodiment, the lateral thickness 323 of each carrier assembly 240 may be equal to a lateral distance that is greater than 0.05 inches, such as greater than 0.10 inches, or greater than 0.15 inches, or greater than 0.20 inches, or greater than 0.30 inches, including any thicknesses defined within such range(s) in increments of 0.02 inches. Moreover, in another embodiment, the lateral thickness 323 may be greater than 0.05 inches and less than 1 inch, such as greater than 0.10 inches and less than 0.75 inches, or greater than 0.15 inches and less than 0.50 inches, or greater than 0.20 inches and less than 0.40 inches, or greater than 0.20 inches and less than 0.30 inches, including any thicknesses defined within such range(s) in increments of 0.02 inches. Such a reduced lateral thickness is significantly smaller than prior art assemblies used to support conventional drapes relative to an associated rail.

It should also be appreciated that, in general, the lateral thickness 323 of the carrier assemblies 240 may be reduced relative to prior art assemblies given the absence of an active pivot system within the disclosed mounting system 200. Specifically, as indicated above, each drape connector 236 is simply configured to freely or passively pivot relative to the connector's respective carrier 230 as the cellular drape 104 is moved between the extended and retracted positions. As such, without the need for the bulky components typically included within an active pivot system, the various components of the mounting system 200 (including the carrier assemblies 240) can be designed to be very compact.

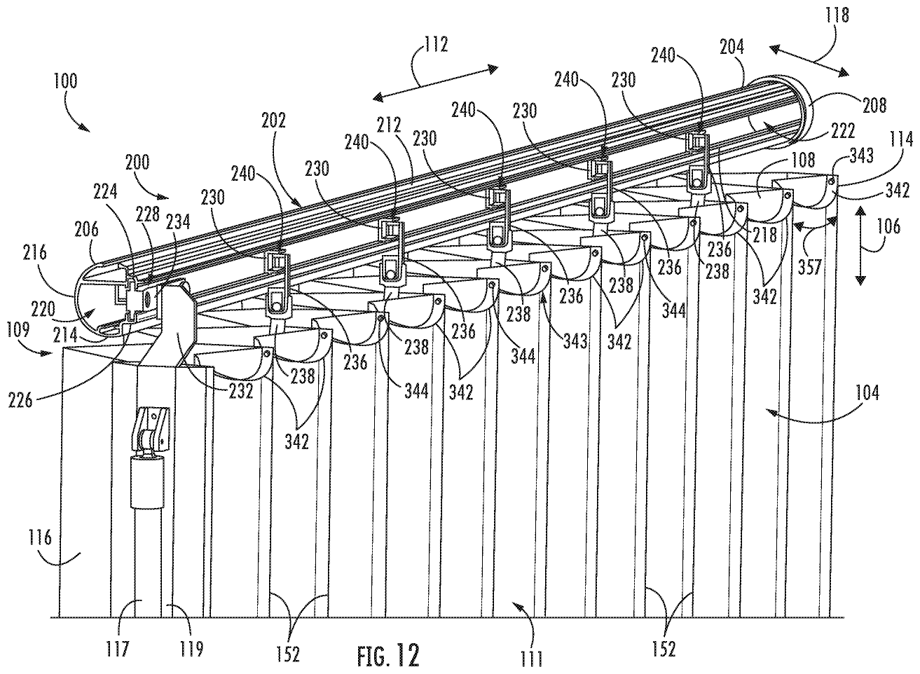

Additionally, it should be appreciated that, as an alternative to including internally located spacers (e.g., the spacers 242 described above reference to FIGS. 5, 8, and 11 located within the rail 202), the disclosed mounting system 200 may, instead, include one or more externally located spacers. For example, FIG. 12 illustrates a perspective view of an alternative embodiment of the portion of the covering assembly 100 shown in FIG. 5, particularly illustrating the mounting system 200 including an external spacer(s) 342 in accordance with aspects of the present disclosure.

As shown in FIG. 12, as opposed to internal spacers located within the interior of the rail 202, the mounting system 200 includes external spacers 342 positioned outside of the rail 202 and coupled directly to a portion of the cellular drape 104. For example, in the illustrated embodiment, the spacers 342 are formed by a continuous strip of material 343 extending along a portion of the rear side or face 111 of the drape 104 at or adjacent to the drape's top end 108 and being coupled to the drape 104 at various locations spaced apart along the lateral direction 112. Specifically, the continuous strip of material 343 is coupled across the rear pleat peaks 152 of the drape 104 along the top end 108 of the drape 104 such that the strip of material 343 extends over the top end 108 of the drape 104 at each rear pleat peak 152, with each spacer 342 being formed end-to-end by the section of the strip of material 343 extending laterally between each pair of adjacent rear pleat peaks 152. In such an embodiment, a length 357 defined between the ends of each spacer 342 (e.g., as defined by the portion or section of the strip of material 343 extending laterally between each pair of adjacent rear pleat peaks 152) may define the maximum lateral spacing between the adjacent pleat peaks 152 and, thus, may set the maximum peak-to-peak distance 142 for the cellular drape 104.

As an alternative to a continuous strip of material, the spacers 342 may be formed from separate strips of material coupled between each pair of adjacent rear pleat peaks 152. In such an embodiment, the length of each separate strip of material extending laterally between each pair of adjacent rear pleat peaks 152 may define the maximum lateral spacing between the adjacent pleat peaks 152 and, thus, may set the maximum peak-to-peak distance 142 for the cellular drape 104.

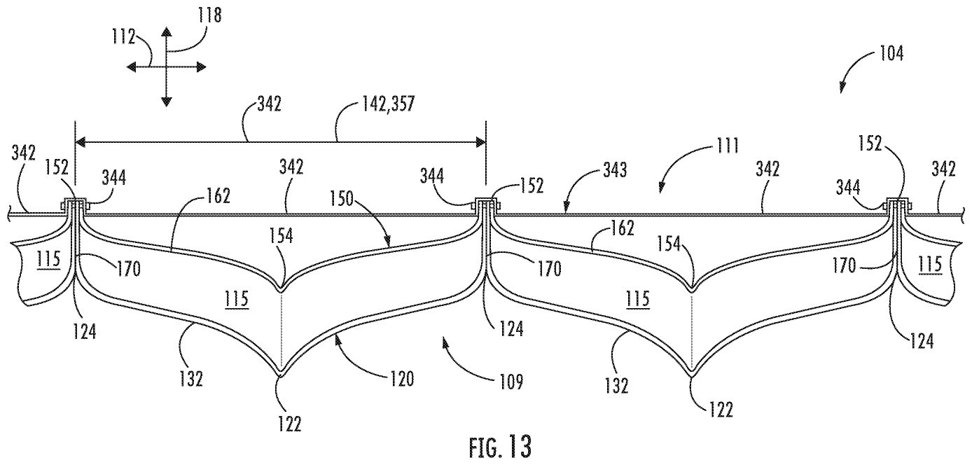

It should be appreciated that, when the spacers 342 are formed from a strip(s) of material (e.g., a continuous strip of material or separate strips of material), the material may correspond to a relatively flexible material, such as a strip(s) of fabric material, a strip(s) of film material, a strip(s) of flexible polymer material, and/or any other suitable material. It should also be appreciated that, as opposed to being coupled between the rear pleat peaks 152 along the rear side 111 of the drape 104 at a location at or adjacent to the drape's top end 108, the spacers 342 may, instead, be coupled between any other laterally spaced portions of the drape 104 at any other suitable location(s) that allows the spacers 342 to function as described herein. For example, FIG. 13 illustrates an alternative embodiment in which the spacers 342 are formed from a continuous strip of material 343 coupled between the rear pleat peaks 152 along the rear face 111 of the drape 104 such that the strip of material 343 wraps around each rear pleat peak 152 (e.g., as opposed to extending over the top end 108 of the drape 104 at each rear pleat peak 152 as shown in FIG. 12). In another embodiment, the strip of material 343 may extend through the rear pleat peaks 152. Alternatively, as indicated above, separate strips of material may simply extend between adjacent rear pleat peaks 152 without wrapping over or extending across the peaks 152.

Additionally, it should be appreciated that any suitable fastening or coupling means may be used to couple the external spacers 342 to the drape 104. For instance, in the embodiments shown in FIGS. 12 and 13, a fastener(s) 344 is used to couple the associated strip(s) of material to each rear pleat peak 152. In such an embodiment, the fastener(s) 344 may correspond to any suitable fastening device, such as a button, snap, rivet, pin, clip, and/or the like. In another embodiment, the external spacers 342 may be coupled to the drape 104 using any other suitable means, such as by adhering the associated strip(s) of material to the drape 104 at each attachment location using a suitable adhesive(s) or by sewing the associated strip(s) of material to the drape 104 at each attachment location.

By utilizing the external spacers 342 as opposed to the internal spacers 242 described above, various unique advantages may be achieved. For example, the external spacers may reduce the amount of componentry located within the interior of the rail 202 (e.g., by eliminating the spacers 242) and may also allow for the configuration of the carrier assemblies 240 to be simplified. For instance, the carrier 230 of each carrier assembly 240 may be configured without the above-described spacer portion 263 (FIG. 9). In such an embodiment, each carrier 230 may, for example, simply include the base portion 261 (FIG. 9) configured to be slidable or movable within the rearwardly-facing slot 222 of the rail 202. In addition, by configuring the disclosed mounting system 200 to include the external spacers 342, the interior of the rail 202 and/or the carrier assemblies 240 need not be configured to accommodate the stacked, cantilevered spacer configuration shown in FIG. 11 when the drape 104 is moved to the retracted position. Rather, the carrier assemblies 240 may simply stack up or abut against one another in the lateral direction 212 without the inclusion of the internal spacers 242.

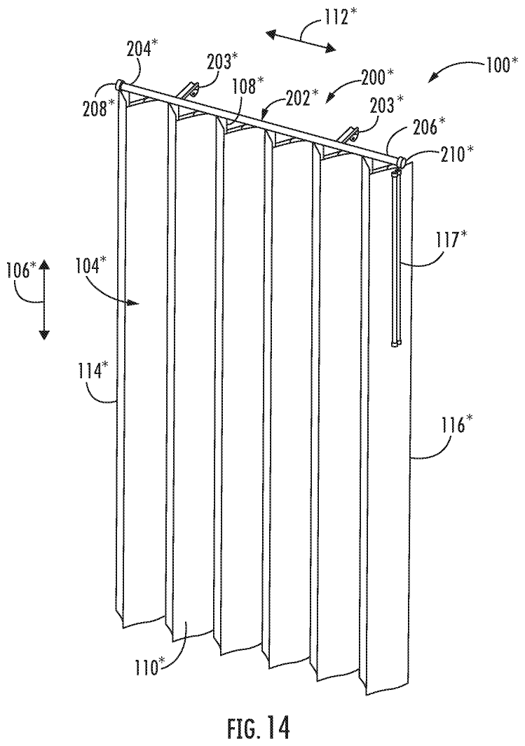

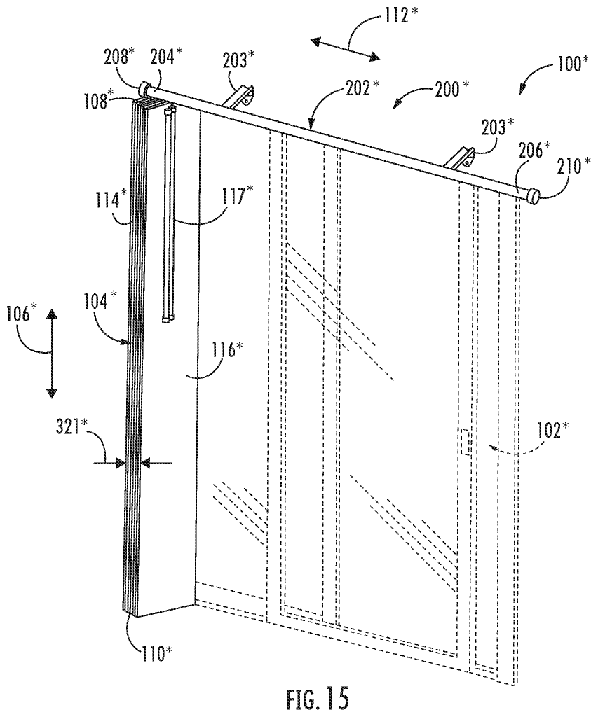

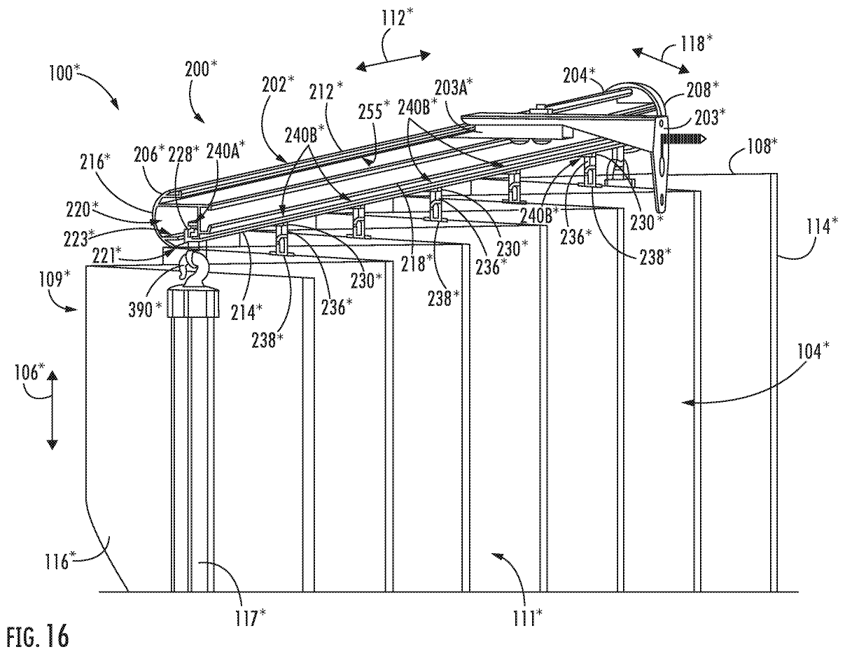

Referring now to FIGS. 14 and 15, another embodiment of a covering assembly 100* for covering an architectural structure 102* (FIG. 15) is illustrated in accordance with aspects of the present disclosure. In general, the covering assembly 100* shown in FIGS. 14 and 15 and its associated components, features, and/or structures (which will be described in more detail below with reference to FIGS. 16-24) are configured similar to the covering assembly 100 described above with reference to FIGS. 1 and 2 and its associated components, features, and/or structures (e.g., as described above with reference to FIGS. 5-13). As such, the components, features, and/or structures of the covering assembly 100* that are the same or similar to corresponding components, features, and/or structures of the covering assembly 100 described above will be designated by the same reference character with an asterisk (*) added. Additionally, when a given component, feature, and/or structure of the covering assembly 100* is configured to generally perform the same function as the corresponding component, feature, and/or structure of the covering assembly 100 described above, a less detailed description of such component/feature/structure will be provided below for the sake of brevity.

In general, the covering assembly 100* includes a vertical cellular drape 104* and an associated mounting system 200* for mounting the cellular drape 104* relative to an architectural structure 102*. Similar to the embodiment described above with reference to FIGS. 1 and 2, the cellular drape 104* is moveable horizontally or laterally between an extended position (FIG. 14) and a retracted position (FIG. 15). When extended, the cellular drape 104* is configured to extend across and at least partially cover the adjacent architectural structure 102*. For example, in one embodiment, the cellular drape 104* is configured to extend in a heightwise or vertical direction of the covering assembly 100* (indicated by arrow 106* shown in FIGS. 14 and 15) between a top end 108* and a bottom end 110* and in a horizontal or lateral direction of the covering assembly 100* (indicated by arrow 112* in FIGS. 14 and 15) between a first lateral end 114* and a second lateral end 116*. Additionally, when retracted, the cellular drape 104* is generally configured to be collapsed in the lateral direction 112* to allow the drape 104* to be positioned along one side of the adjacent architectural structure 102*, thereby exposing at least a portion of the architectural structure 102*.

As shown in FIGS. 14 and 15, the mounting system 200* generally includes a rail 202* configured to be installed relative to the adjacent architectural structure 102* (FIG. 15) (e.g., by using suitable mounting brackets 203* coupled between the rail 202* and a wall or other support structure adjacent the architectural structure 102*), such as at a location at or adjacent to the top of the architectural structure 102*. In general, the rail 202* is configured as an elongated support member extending longitudinally in the lateral direction 112* of the covering assembly 100* between a first rail end 204* and a second rail end 206*. Additionally, as shown in the illustrated embodiment, endcaps are installed at the opposed ends 204*, 206* of the rail 202*, such as by installing a first endcap 208* at the first rail end 204* and a second endcap 210* at the second rail end 206*. As will be described in greater detail below, similar to the embodiment of the rail 202 described above with reference to FIG. 5, the rail 202* is configured to be provided in operative association with a plurality of carriers and related components for supporting the cellular drape 104* relative to the rail 202* in a manner that allows the drape 104* to be moved between the extended and retracted positions.

Additionally, the covering assembly 100* may include a control system to facilitate moving the cellular drape 104* between the extended and retracted positions. For example, as shown in the illustrated embodiment, the covering assembly 100* includes an operating wand 117* positioned at one of the lateral ends of the cellular drape 104* (e.g., the second lateral end 116*). In such an embodiment, a user of the covering assembly 100* may pull/push the wand 117* to move the cellular drape 104* relative to the rail 202* between the extended and retracted positions. It should be appreciated that, although not shown, a similar control system (e.g., a second operating wand) may also be provided in operative association with the other lateral side of the drape 104.

As indicated above, the disclosed mounting system 200* is generally configured to support a drape, such as the vertical cellular drape 104* shown in FIGS. 14 and 15, relative to an architectural structure. In one embodiment, the vertical cellular drape 104* may, for example, be configured the same as or similar to the drape configuration described above with reference to FIGS. 3 and 4. In such an embodiment, when moved towards the retracted position, the cellular drape 104* may be collapsed into a folded or accordion-style configuration having a substantially flattened cellular profile, thereby allowing the drape 104* to take on a very compact lateral profile (e.g., by defining a minimal lateral width 321* (FIG. 15). However, as the drape 104* is moved towards the extended position, the internal cells of the drape 104* may expand outwardly, thereby allowing the cellular drape 104* to be provided with a desired amount of fullness or cross-wise depth.

Referring now to FIG. 16, a rear perspective view of a portion of the covering assembly 100* shown in FIG. 14 is illustrated in accordance with aspects of the present disclosure, particularly illustrating various components, features, and/or structures of one exemplary embodiment of a mounting system 200* for supporting a vertical cellular drape relative to an architectural structure. As indicated above, the mounting system 200* includes a rail 202* extending lengthwise or laterally between opposed, first and second rail ends 204*, 206*. In addition, the mounting system 200* may also include corresponding first and second endcaps 208*, 210* configured to be installed at the first and second rail ends 204*, 206*, respectively. As shown in FIG. 16, for purposes of illustration, the second endcap 210* has been removed from the rail 202* to allow aspects of the mounting system 200* to be viewed from such end 206* of the rail 202*.

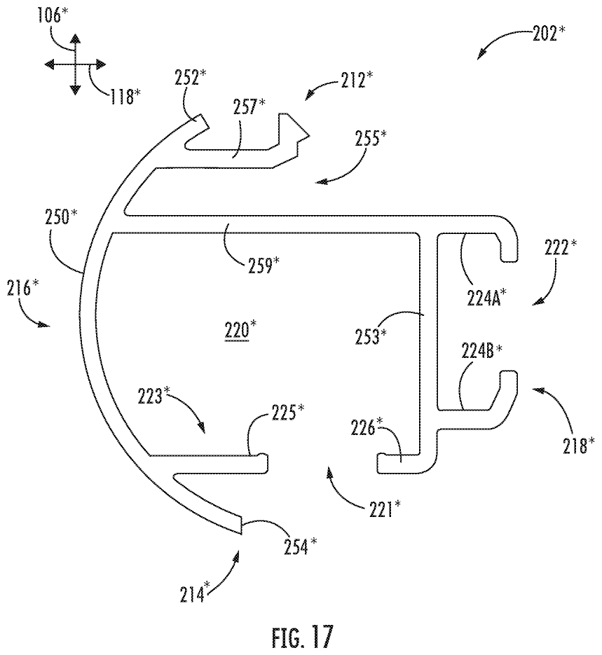

As shown in the illustrated embodiment, the rail 202* of the mounting system 200* extends in the vertical direction 106* of the covering assembly 100* between a top side 212* and a bottom side 214*. The rail 202* also extends in a cross-wise direction of the covering assembly 100* (indicated by arrow 118 in FIG. 16) between a front side 216* and a rear side 218* configured to face in the opposite direction. In one embodiment, the rail 202* may be hollow. For example, as shown in FIG. 16, the rail 202* defines an interior cavity 220* extending between the rail's opposed lateral ends 204*, 206*. Additionally, as shown in FIG. 16, the rail 202* defines a downward facing mounting slot 221* along the bottom side 214* of the rail 202* that extends lengthwise or laterally between the opposed lateral ends 204*, 206* of the rail 202*. As such, the bottom mounting slot 221* is open along the bottom side 214* of the rail 202* and provides access to the rail's interior cavity 220*. Moreover, in several embodiments, the rail 202* includes a track 223* extending along the length of the mounting slot 221*. For instance, as will be described below with reference to FIG. 17, in one embodiment, the rail 202* includes opposed track walls 225*, 226* (FIG. 17) positioned along each side of the slot 221* that form a planar or horizontally oriented track along the length of the slot 221*.

Similar to the previously described embodiment, the mounting system 200* also includes a plurality of carriers configured to be slidably or movably supported by the rail 202* to allow the carriers to be slid or moved along the length of the rail 202* between the rail's first and second ends 204*, 206*. Specifically, in the illustrated embodiment, the carriers are configured to be slidably or movably supported within the bottom mounting slot 221* (e.g., via the associated track 223*) such that each carrier may be slid or moved between the opposed ends 204*, 206* of the rail 202*. In one embodiment, each carrier is, in turn, coupled to a portion of the cellular drape 104* (e.g., via one or more additional components of the mounting system 200*). Thus, as the cellular drape 104* is moved between the extended and retracted positions (e.g., via use of the operating wand 117*), the carriers may be configured to move or slide within the slot 221* along the bottom side 214* of the rail 202* with corresponding movement of the drape 104* to support the drape 104* relative to the rail 202*.

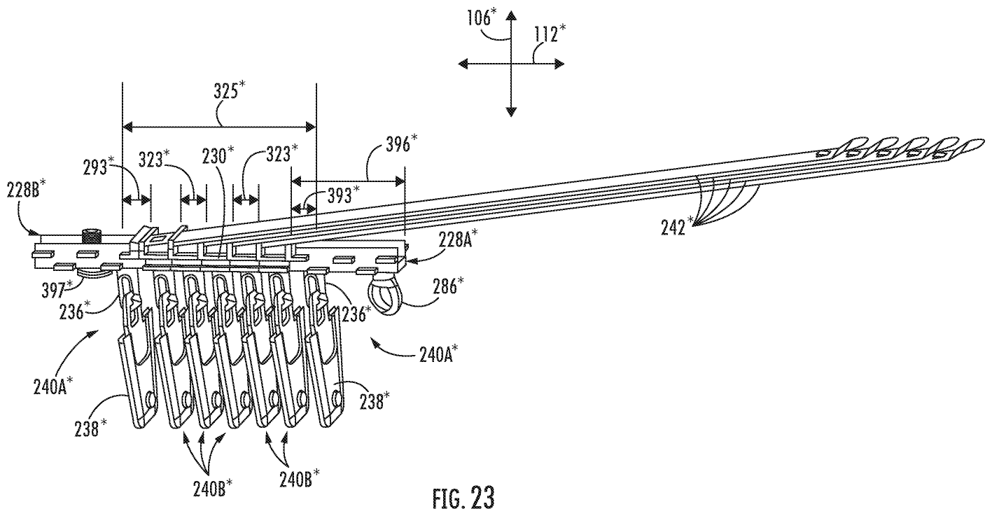

As shown in FIG. 16, in several embodiments, the mounting system 200* includes at least one end carrier 228* and one or more intermediate carriers 230* configured to be supported within the bottom mounting slot 221* for slidable movement along the length of the rail 202*. Each end carrier 228* is configured to be coupled to the cellular drape 104* at one of the drape's lateral ends 114*, 116*. For example, in the illustrated embodiment, the mounting system 200* includes an end carrier 228* coupled to the cellular drape 104* at the drape's second lateral end 116*. However, in other embodiments, the end carrier 228* may be coupled to the opposite side of the drape 104* or the mounting system 200* may include a pair of end carriers 228* (e.g., as will be described below with reference to FIG. 23), with each end carrier 228* being coupled to one of the lateral ends 114*, 116* of the drape 104*. As shown in FIG. 16, in addition to being coupled to the drape 104* at the drape's second lateral end 116*, the end carrier 228 is also configured to be coupled to the adjacent operating wand 117*. As such, when a user of the disclosed covering assembly 100* grasps the operating wand 117* to pull/push the drape 104* between the extended and retracted positions, the opening/closing force applied to the wand 117* is transmitted to the end carrier 228* to cause the end carrier 228* to be moved relative to the rail 202* in the desired direction.

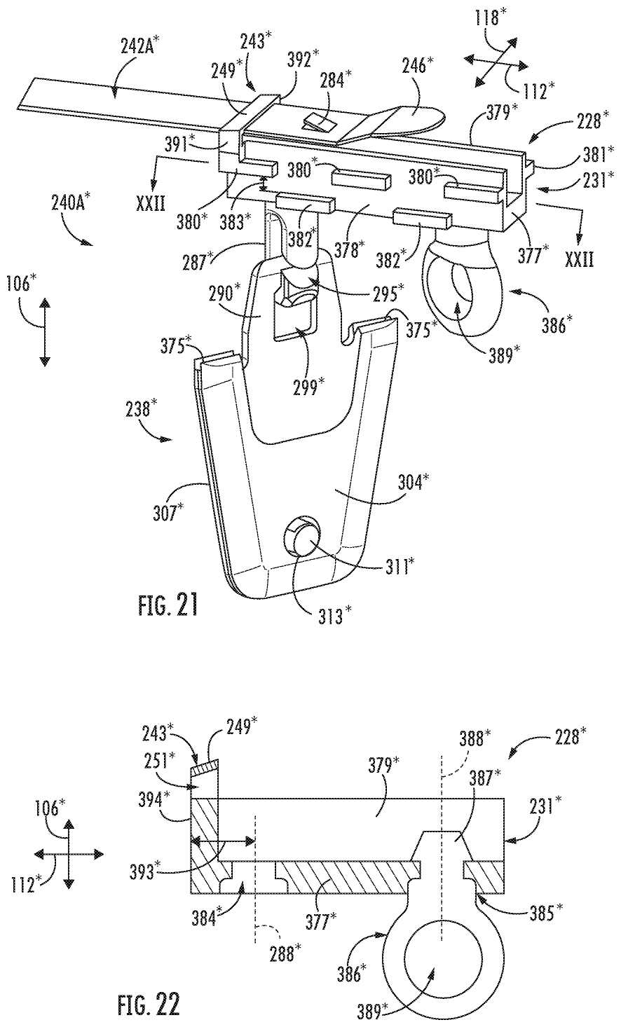

Additionally, as shown in FIG. 16, the intermediate carriers 230* are configured to be coupled to portions of the cellular drape 104* at or adjacent to the top end 108* of the drape 104*, with the drape portion being spaced apart from one another between the first and second lateral ends 114*, 116* of the drape 104* such that the intermediate carriers 230* function to support the drape 104* relative to the rail 202* at such spaced apart locations along the drape's width. As will be described in greater detail below, in several embodiments, each intermediate carrier 230* may be coupled to a portion of the cellular drape 104* via an associated drape connector 236* and related clip 238*. For example, as shown in FIG. 16, a drape connector 236* is coupled to the bottom end of each intermediate carrier 230* and extends downwardly therefrom to an associated drape clip 238* coupled between the drape connector 236* and the adjacent portion of the cellular drape 104*. As such, via the connection provided by the drape connector/clip 236*, 238*, each intermediate carrier 230* is configured to be coupled to a separate portion of the cellular drape 104* at or adjacent to the top end 108* of the drape 104*. By coupling the intermediate carriers 230* between the rail 202* and the drape 104*, the carriers 230* are allowed to slide or move relative to the rail 202* along the mounting slot 221* as the portions of the cellular drape 104* supported by the intermediate carriers 230* are moved to adjust the configuration of the drape 104* between the extended and retracted positions. As will be described below with reference to FIGS. 21 and 22, the end carrier 228* may also be configured to be coupled to the drape 104* via an associated drape connector/clip 236*, 238* of the mounting system 200*.

For purposes of discussion, each individual assembly of a carrier, connector, and clip of the mounting system 200* will be generally described herein as forming a carrier assembly 240*, with each individual assembly of an end carrier, connector, and clip also being referred to herein as an end carrier assembly 240A* and each individual assembly of an intermediate carrier, connector, and clip also being referred to herein as an intermediate carrier assembly 240B*. However, it should be appreciated that, in other embodiments, each carrier assembly 240* may include only a sub-combination of such components, such as by configuring each carrier assembly 240* to include only a carrier 228*, 230* and the associated drape connector 236* (e.g., when the connector 236* is configured to be coupled directly to the drape 104*).

It should also be appreciated that the various carrier assemblies 240* may be coupled to any suitable portion of the cellular drape 104* disposed at or adjacent to the drape's top end 108* that allows the drape 104* to be vertically supported relative to the rail 202* by such assemblies 240*. For example, in one embodiment, each carrier assembly 240* may be coupled to one of the cross-wise extending ribs 170 (FIG. 3) of the vertical cellular drape 104*, such as by coupling a carrier assembly 240* to a top portion of every cross-wise rib 170 or every other cross-wise rib 170 along the lateral width of the drape 104*. Alternatively, when headers are installed at or adjacent to the top end 108* of the cellular drape 104* (e.g., as separate strips of material disposed at the top end of each inner cell 115 (FIG. 3)), a carrier assembly 240* may, for example, be coupled to every header or every other header along the lateral width of the drape 104*.

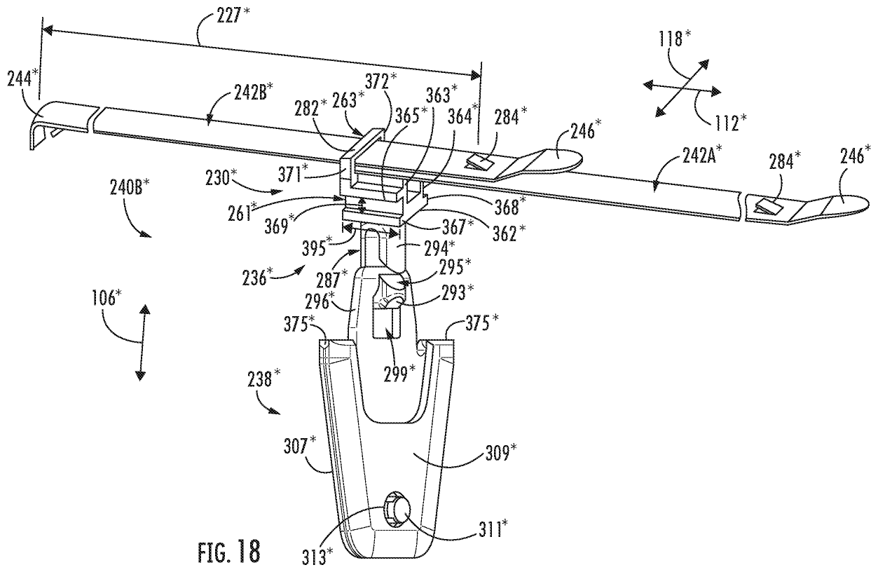

Moreover, as will be described below, the disclosed mounting system 200* also includes a plurality of sliders or spacers 242* (FIGS. 18 and 20-22) (referred to herein simply as “spacers” for the sake of convenience without intent to limit). In general, the spacers 242* may be configured the same as the spacers 242 described above with reference to FIGS. 5, 8, 10, and 11. For instance, the spacers 242* may be configured to extend lengthwise within the interior cavity 220* of the rail 202*, with each spacer 242* being coupled or engaged between an adjacent pair of carriers 228*, 230* (e.g., by configuring each spacer 242* to be fixedly or non-slidably coupled to or engaged with one of the carriers of a given pair of adjacent carriers and slidably coupled to or engaged with the other carrier of the pair of adjacent carriers). In this regard, the spacers 242* may serve to couple all of the carriers 228*, 230* together, thereby allowing the carriers 228*, 230* to be pulled sequentially across the length of the rail 202* as the cellular drape 104* is being moved between the extended and retracted positions.

However, it should be appreciated that, as an alternative to including internally located spacers 242*, the disclosed mounting system 200* may, instead, include one or more externally located spacers. For instance, in one embodiment, the mounting system 200* may include external spacers configured the same as or similar to the external spacers 342 described above with reference to FIGS. 12 and 13. For instance, the external spacers may be positioned outside of the rail 202* and coupled directly to a portion of the cellular drape 104* to set the maximum peak-to-peak distance 142 (FIG. 13) for the cellular drape 104*.

Referring now to FIG. 17, an end view of the second end 206* of the rail 202* shown in FIG. 16* is illustrated in accordance with aspects of the present disclosure, with the carriers 228*, 230* and other related components being removed for purposes of illustration. Similar to the rail 202 described above with reference to FIG. 6, the rail 202* may be configured to define an outer profile having an appearance similar to a conventional drape or curtain rod, such as by configuring the rail's outer profile to have a substantially circular cross-sectional shape across at least a portion of the outer perimeter of the 202*. For instance, as particularly shown in FIG. 17, the outer profile of the rail 202* is semi-circular or arcuate-shaped across all or a substantial portion of the front side 216* of the rail 202*, such as across an arcuate-shaped front wall 250* of the rail 202* extending from an upper circumferential end 252* to a lower circumferential end 254*, with the upper circumferential end 252* of the wall 250* being located along the top side 212* of the rail 202* and the lower circumferential end 254* of the wall 250* being located along the bottom side 214* of the rail 202*. As such, when viewed from the front side of the covering assembly 100* (e.g., the view shown in FIGS. 14 and 15), the outer profile of the rail 202* generally appears to have a circular overall profile shape.

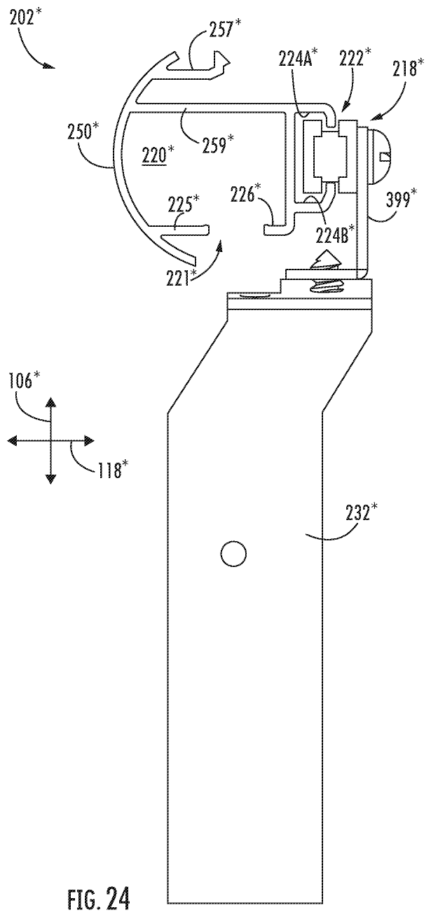

Additionally, in several embodiments, the rail 202* is configured in a manner so as to accommodate one or more components of each carrier assembly 240* along the bottom side 214* of the rail 202*. For example, as indicated above, the bottom mounting slot 221* of the rail 202* is configured to allow the carriers 228*, 230* to be slidably mounted along the bottom side 214* of the rail 202*. Moreover, in addition to the mounting slot 221*, the rail 202* may also include or define other features or structure for allowing one or more other components of the mounting system 200* to be coupled to the rail 202*. For instance, as shown in FIG. 17, a bracket slot 255* is defined between an upper bracket wall 257* of the rail 202* and an opposed base wall 259* of the rail 202* that extends from the arcuate-shaped front wall 250* to an open end of the slot 255* defined along the rear side 218* of the rail 202*. As shown in FIG. 16, such bracket slot 255* may be configured to receive an end 203A* of each mounting bracket 203* of the mounting system 202*, thereby allowing the bracket 203* to support the rail 202* relative to the adjacent architectural structure. Additionally, as shown in FIG. 17, a rear mounting slot 222* may also be defined along the rear side 218* of the rail 202*. Similar to the rear mounting slot 222 described above with reference to FIG. 6, the rear mounting slot 222* defines an opposed pair of upper and lower tracks 224A*, 224B*. As will be described below with reference to FIG. 24, an optional support bracket 232* may be supported relative to the rail 202* via the tracks 224A*, 224B* of the rear mounting slot 222*.

As indicated above and as illustrated in FIG. 17, the rail 202* is configured to define or form a track 223* relative to the bottom mounting slot 221 for slidably supporting the carriers 228*, 230* relative to the rail 202. Specifically, in the illustrated embodiment, the rail 202* includes opposed first and second track walls 225*, 226* positioned relative to bottom mounting slot 221* such that the track walls 225*, 226* define or form a horizontally oriented track extending along the length of the slot 221*. In one embodiment, the track formed by the track walls 225*, 226 may be smooth or flat (e.g., planar) to facilitate sliding of the carriers 228*, 230* relative to the rail 202. As shown in FIG. 17, the first track wall 225* extends in the cross-wise direction 118* of the covering assembly 100* between the front wall 250* of the rail 202* and the mounting slot 221*, while the opposed second track wall 226* extends in the cross-wise direction 118* between the mounting slot 221* and a rear wall 253* of the rail 202*. As will be described below, corresponding features or structure of each carrier 238*, 230* may be configured to be supported relative to the rail 202* via the track walls 225*, 226* to allow the carriers 238*, 230* to be slid or moved along the length of the mounting slot 221* between the opposed ends 204*, 206* of the rail 202*.

In one embodiment, the track walls 225*, 226* (and thus, the bottom mounting slot 221* and associated track 223* defined by the track walls 225*, 226*) may be recessed in the heightwise direction 106* of the covering assembly 100* relative to the bottom side 214* of the rail 202*. Specifically, as shown in FIG. 17, a lower portion of the arcuate-shaped front wall 250* projects vertically below the track walls 225*, 226* as the front wall 250* extends towards the lower circumferential end 254*. As a result, the lower portion of the front wall 250* may serve to shield the mounting slot 221* from view. Moreover, such recessing of the slot 221* and associated track 223* may allow a portion of each adjacent carrier assembly 240* to be shielded by the front wall 250*, thereby obscuring such portion(s) of the mounting system 200* from view.

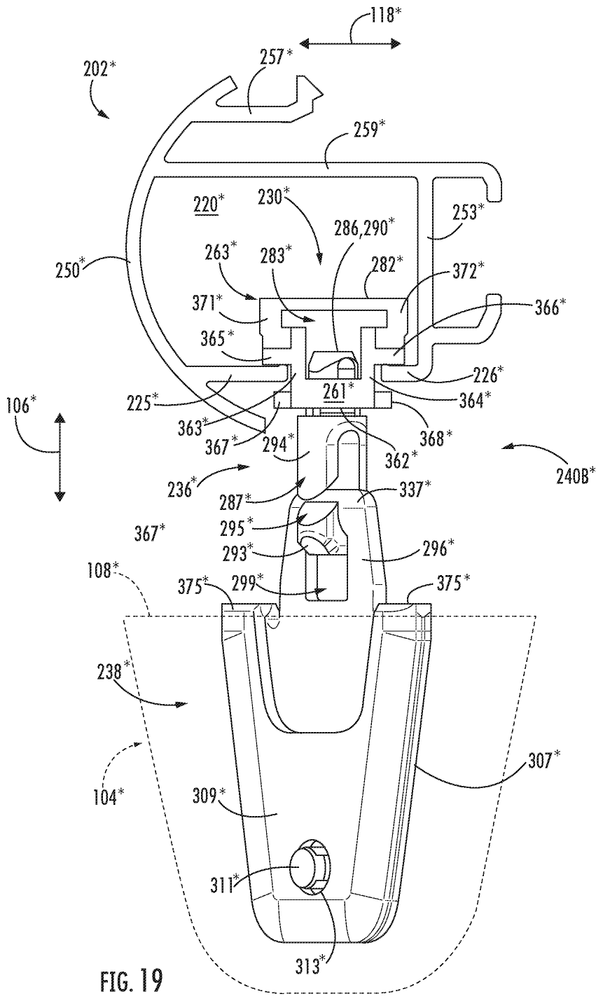

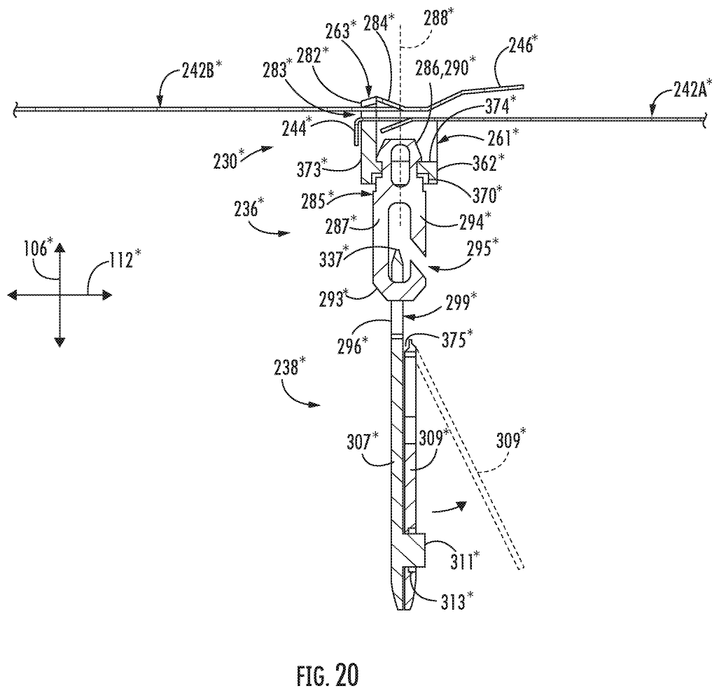

Referring now to FIGS. 18-20, differing views of one embodiment of one of the intermediate carrier assemblies 240B* of the mounting system 200* described above with reference to FIG. 16 is illustrated in accordance with aspects of the present disclosure. Specifically, FIG. 18 illustrates a perspective view of the intermediate carrier assembly 240B* with adjacent first and second spacers 242A*, 242B* of the disclosed mounting system 200* being installed relative thereto. FIG. 19 illustrates a side view of the intermediate carrier assembly 240B* as installed relative the rail 202* (with the adjacent spacers 242A*, 242B* being removed from view for purposes of illustration). Additionally, FIG. 20 illustrates a cross-sectional view of the intermediate carrier assembly 240B* and adjacent spacers 242A*, 242B* shown in FIG. 18.

As indicated above, in several embodiments, each intermediate carrier assembly 240B* includes an intermediate carrier 230*, a drape connector 236*, and a drape clip 238* of the disclosed mounting system 200*, with the drape connector 236* and drape clip 238* being coupled between the intermediate carrier 230* and a portion of the cellular drape 104* to allow the drape 104* to be supported by the carrier assembly 240B* relative to the rail 202*. For instance, as particularly shown in FIG. 19, when installed relative to the rail 202*, the carrier assembly 240B* may allow the cellular drape 104* (indicated in phantom lines in FIG. 19) to be suspended from the rail 202*.

As shown in the illustrated embodiment, the intermediate carrier 230* includes both a base portion 261* and a spacer portion 263*. As will be described below, the base portion 261* may be configured to slidably couple the carrier 230* to the rail 202* within the bottom mounting slot 221*. In addition, the base portion 261* may be configured for coupling the adjacent drape connector 236* to the carrier 230*. Moreover, as will be described below, the spacer portion 263* of the intermediate carrier 230* may be configured to allow one or more spacers 242* of the mounting system 200* to be coupled thereto and/or engaged therewith within the interior of the rail 202*.

As particularly shown in FIG. 19, the base portion 261* of the intermediate carrier 230* generally defines a substantially “U-shaped” profile including a bottom wall 362* and first and second sidewalls 363*, 364* extending vertically from the bottom wall 362*, with the sidewalls 363*, 364* being configured to extend through the mounting slot 221* when the carrier 230* is installed relative to the rail 202*. Additionally, in several embodiments, the intermediate carrier 230* may include one or more track engagement features or structure extending outwardly from the sidewalls 363*, 364* of the base portion 261* for engagement with the track walls 225*, 226* of the rail 202*, thereby allowing the carrier 230* to be supported within the slot 221* relative to the rail 202*. Specifically, as shown in the illustrated embodiment, the intermediate carrier 230* includes first and second track flanges 365*, 366* extending outwardly from the first and second sidewalls 363*, 364* of the base portion 261*, respectively, such that each track flange 365*, 366* is configured to be supported by the adjacent track wall 225*, 226* when the carrier 230* is installed within the mounting slot 221*. For example, as particularly shown in FIG. 19, the track flanges 365*, 366* are configured to be supported directly on the upper surfaces of the track walls 225*, 226*, thereby providing a contact interface between the carrier 230* and the rail 202* across which the carrier 230* may be slid or moved along the length of the rail 202*.

Additionally, in one embodiment, the intermediate carrier 230* may further include a pair of opposed stop flanges 367*, 368* spaced vertically below the track flanges 365*, 366* to maintain the vertical positioning of the carrier 230* relative to the rail 202*. Specifically, as shown in FIG. 19, the stop flanges 367*, 368* are positioned below the track flanges 365*, 366* such that, when the carrier 230* is installed within the slot 221*, each track wall 225*, 226* is vertically trapped within a gap or channel 369* (FIG. 18) defined between the adjacent pair of track/stop flanges, thereby preventing the carrier 230* from being pushed upwardly into the interior of the rail 202* beyond the position of the stop flanges 367*, 368*. In such an embodiment, it should be appreciated that the intermediate carrier 230* may be configured to be installed within the mounting slot 221* by sliding the carrier 230* onto the track 233* (FIG. 17) at one of the ends of the rail 202* such that the track walls 225*, 226* are received within the channel 269* defined between the track/stop flanges.

As indicated above, in addition to slidably coupling the intermediate carrier 230* to the rail 202*, the base portion 261* of the carrier 230* may also be configured to support the associated drape connector 236*. For instance, as particularly shown in FIG. 20, a pivot opening 370* is defined through the bottom wall 362* of the base portion 361* for pivotably coupling the connector 236* to the carrier 230*. In such an embodiment, as will be described in greater detail below, the drape connector 236* may be configured to be inserted through the pivot opening 370* to suspend the drape connector 236* from the carrier 230* in a manner that allows the connector 236* to freely rotate or pivot relative to the carrier 230*.

Additionally, as indicated above, the intermediate carrier 230* also includes a spacer portion 263* extending from or positioned relative to the base portion 261* such that spacer portion 263* is configured to be disposed the within the interior cavity 220* of the rail 202* when the carrier 230* is installed relative to the mounting slot 221*. In general, the spacer portion 263* of the intermediate carrier 230* may be configured to allow the carrier 230* to be coupled to or engaged with one or more of the spacers 242* of the mounting system 200*. For example, as particularly shown in FIG. 19, the spacer portion 263* includes opposed spacer walls 371*, 372* extending outwardly from the base portion 261* of the intermediate carrier 230* (e.g., extending upwardly from the track flanges 365*, 366*) and an engagement bar or wall 282* extending between the opposed spacer walls 371*, 372* at a location spaced apart vertically from the sidewalls 363*, 364* of the base portion 261. As such, a spacer gap 283* is defined vertically between the engagement wall 282* and the top ends of the sidewalls 363*, 364* through which a given spacer 242* of the mounting system 200* is configured to extend to allow the spacer 242* to be slidably coupled to the intermediate carrier 230*.

For example, in the views illustrated in FIGS. 18 and 20, the intermediate carrier 230* is shown as installed relative to two spacers 242A of the disclosed mounting system 200* (e.g., a first spacer 242A* and a second spacer 242B*). Similar to the embodiment described above with reference to FIGS. 8 and 10, the first spacer 242A* is configured to be non-slidably coupled to or engaged with the intermediate carrier 230*, whereas the second spacer 242B* is configured to be slidably coupled to or engaged with the intermediate carrier 230*. For example, as particularly shown in FIG. 20, a first end 244* of the first spacer 242A* is coupled to or engaged with the intermediate carrier 230*, such as by being wrapped around an end face 373* (FIG. 20) of the spacer portion 263* of the intermediate carrier 230*. In such an embodiment, the first spacer 242A* is configured to be slidably coupled to or engaged with the spacer portion of an adjacent carrier between the spacer's first end 244* and its opposed second end 246*. Similarly, as shown in FIGS. 18 and 20, the second spacer 242B* is shown as extending through the spacer gap 283* defined by the spacer portion 263* of the intermediate carrier 230* to allow the carrier 230* to move relative to the spacer 242B* between the spacer's second end 246* and its opposed first end 244* (which may, in turn, be configured to be coupled to the spacer portion of an adjacent carrier). Additionally, as particularly shown in the illustrated embodiment, an engagement tab or stop 284* may be defined at or adjacent to the second end 246* of each spacer 242A*, 242B*. As such, when the carrier 230* is moved relative to the second spacer 242B*, the stop 284* may prevent the carrier 230* and the spacer 242B* from becoming decoupled from each other. For example, the intermediate carrier 230* may be moved relative to the spacer 242B* towards the spacer's second end 246* until the engagement wall 282* of the carrier 230* contacts or otherwise engages against the stop 284* of the spacer 242B*, thereby preventing further relative movement of the carrier 230* in such direction. In such an embodiment, a length 227* (FIG. 18) of each spacer 242A*, 242B* defined between its first end 244* and its engagement tab or stop 284* may be selected so as to set the desired range of relative travel between adjacent carriers, thereby, in turn, allowing the maximum peak-to-peak distance to be set for the cellular drape 104*.

It should be appreciated that the specific length 227* (FIG. 18) selected for the spacers 242* of the disclosed mounting system 200* may generally vary depending on the configuration of the covering assembly 100*, as well as the desired maximum peak-to-peak distance for the cellular drape 104* (e.g., as selected to allow the desired amount of fullness or cross-wise depth to be achieved when the drape 104* is moved to the extended position). However, in a particular embodiment, the length 227* of each spacer 242* is equal to a length that is greater than 5 inches, such as greater than 5.5 inches, or greater than 6 inches, or greater than 6.5 inches, including any lengths defined within such range(s) in increments of 0.05 inches. Additionally, in another embodiment, the length 227* of each spacer 242* is equal to a length that is less than 8 inches, such as less than 7.5 inches, or less than 7 inches, or less than 6.5 inches, or less than 6 inches, including any lengths defined within such range(s) in increments of 0.05 inches. Moreover, in one embodiment, the length 227* of each spacer 242* may be may greater than 5 inches and less than 8 inches, such as greater than 6 inches and less than 8 inches, or greater than 6.5 inches and less than 7.5 inches, or greater than 6.75 inches and less than 7.25 inches, including any lengths defined within such range(s) in increments of 0.05 inches. Such an increased spacer length is significantly greater than prior art spacers used with conventional mounting systems in association with conventional drapes.

It should also be appreciated that the above-described interaction and/or engagement between the intermediate carrier 230* and the associated spacers 242A*, 242B* may similarly apply to other intermediate carriers 230* of the disclosed mounting system 200*. For example, the spacer portion 263* of each intermediate carrier 230* may have a first spacer non-slidably coupled thereto or engaged therewith and a second spacer slidably coupled thereto or engaged therewith, with the first spacer being slidably coupled to or engaged with an adjacent carrier positioned on one side of the carrier along the lateral direction 112* of the covering assembly 100* and the second spacer being non-slidably coupled to or engaged with an adjacent carrier positioned on the opposed side of the carrier along the lateral direction 112* of the covering assembly 100*. Similarly, it should be appreciated that, for any carrier configured to be coupled to one of the lateral ends 114*, 116* of the drape 104* (e.g., the end carrier 228*), the carrier may only be configured to be coupled to a single spacer 242* of the mounting system 200*.

Moreover, in several embodiments, the intermediate carrier 230* may define a lateral thickness or width 395* (FIG. 18) between the carrier's opposed lateral ends in the lateral direction 112* of the covering assembly 100*. For instance, the lateral width 395* may be defined between the opposed end faces of the intermediate carrier 230* configured to abut against adjacent carriers 228*, 230* of the covering assembly 100* when the drape 104* is moved to the retracted position. As will be described below with reference to FIG. 23, the lateral width 395* of the intermediate carrier 230* may be selected to minimize the overall stacking width of the carrier assemblies 240* when the drape 104* is moved to the retracted position.

Referring still to FIGS. 18-20, as indicated above, the drape connector 236* of each carrier assembly 240B* is generally configured to be coupled between the associated intermediate carrier 230* and an adjacent portion of the cellular drape 104* (e.g., via the associated drape clip 238*) to support the drape 104* relative to the rail 202*. As particularly shown in FIGS. 19 and 20, the drape connector 236* generally corresponds to an elongated member 285* (FIG. 20) extending vertically between opposed top and bottom connector portions 286*, 287*, with the top connector portion 286* configured to be coupled to the intermediate carrier 230* and the bottom connector portion 287* configured to be coupled to the associated drape clip 238*.

In several embodiments, the top connector portion 286* (FIGS. 19 and 20) of the drape connector 236* is configured to be pivotably coupled to the base portion 261* of the intermediate carrier 230* to allow the drape connector 236* to freely pivot relative to the carrier 230* about a vertically oriented pivot axis 288* (FIG. 20) as the drape 104* is being moved between the extended and retracted positions. For example, as shown in FIG. 20, the top connector portion 286* includes an enlarged pivot head 290* configured to be inserted or snapped through the pivot opening 370* defined through the bottom wall 362* of the base portion 361* of the intermediate carrier 230* such that the pivot head 290* is vertically supported by the carrier 230*. Specifically, in one embodiment, the diameter of the pivot head 290* may be slightly larger than the diameter of the pivot opening 370* defined through the bottom wall 362* of the base portion 361*. Thus, as shown in FIG. 20, given its larger diameter, the pivot head 290* may overlap or overhang an inner surface 374* of the bottom wall 362* around the outer perimeter of the pivot opening 370*, thereby allowing the drape connector 236* to be vertically supported relative to the intermediate carrier 230* for pivotable movement about the vertical pivot axis 288* (FIG. 20). Such a pivotable connection between the drape connector 236* and the carrier 230* may allow the connecter 236* to pivot relative to the carrier 230*, as necessary, as the cellular drape 104* is being moved between the extended and retracted positions. It should be appreciated that, given the absence of an active pivot system, such pivoting occurs passively or freely as the cellular drape 104* is being extended or retracted, which allows the drape 104* to flow freely or otherwise behave like a typical drape as the drape is being moved between the extended and retracted positions. It should also be appreciated that, in one embodiment, such passive or free pivoting of the connecter 236* relative to the carrier 230* about the vertical pivot axis 288* may be provided across a given angular range, such as predetermined angular range.

As indicated above, the bottom connector portion 287* of the drape connector 236* is configured to be coupled to the associated drape clip 238*. Specifically, in several embodiments, the bottom connector portion 287* of the drape connector 236* is configured to define an attachment interface or arrangement for allowing the drape clip 238* to be coupled directly thereto, thereby permitting the clip 238* (and, thus, the drape 104*) to be suspended from the connector 236*. For example, as shown in the illustrated embodiment, the attachment interface or arrangement of the bottom connector portion 287* is configured as a hooked or snap-in arrangement including a hooked member 293* and an arm member 294* spaced apart from the hooked member 293* such that an insertion slit 295* is defined therebetween through which a corresponding portion of the drape clip 238* (e.g., a top end 337* (FIG. 20) of the drape clip 238*) is configured to be inserted to allow the clip 238* to be vertically supported relative to the connector 236* in a suspended manner. Once the top end 337* (FIG. 20) of the drape clip 238* is inserted through the insertion slit 295*, the drape clip 238* may rest on or otherwise be supported by the hooked member 293* of the connector 236* to maintain the vertical positioning of the drape clip 238* relative to the connector 236*.

As particularly shown in FIG. 20, the insertion slit 295* is oriented at an angle relative to the heightwise direction 106* of the covering 100*. In such an embodiment, the drape clip 238* may be configured to be oriented at a similar angle when inserting the top end 337* of the clip 238* through the insertion slit 295* to couple the clip 238* to the connector 236*. However, in other embodiments, the insertion slit 295* may have any other suitable configuration and/or angular orientation, such as by configuring the insertion slit 295* in a manner that allows the clip 238* to be hooked onto the connector 236* by passing the top end 337* of the clip 238* through the slit 295* horizontally.

Referring still to FIGS. 18-20, the drape clip 238* of each intermediate carrier assembly 240B* is generally configured to be coupled between the drape connector 236* and the cellular drape 104* to allow the drape 104* to be supported relative to the rail 202*. As noted above, the drape clip 238* may, in several embodiments, be configured to be clipped or hooked onto the bottom connector portion 287* of the drape connector 236* at or adjacent to the top end 337* of the clip 238*. Thus, in several embodiments, the clip 238* may include suitable features, components, and/or structure for coupling the clip 238* to the bottom connector portion 287* of the drape connector 236*. For instance, as shown in the illustrated embodiment, the clip 238* includes a mounting tab 296* defining a hook or clip opening 299* through which the hooked member 293* of the drape connector 236* passes when the clip 238* is coupled to the connector 236*. In such an embodiment, the top end 337* of the drape clip 238* may be configured to be pushed through the insertion slit 295* (e.g., at the same angled orientation of the slit) until the hooked member 293* is aligned with the clip opening 299* in a manner that allows the hooked member 293* to pass through the clip opening 299* as the drape clip 238* is pivoted towards the vertical orientation shown in the illustrated embodiment, thereby allowing the mounting tab 296* to rest or otherwise be supported within the bottom connector portion 287* of the drape connector 236* via the hooked member 293*.

Moreover, the clip 238* may include suitable features, components, and/or structure for coupling the clip 238* to the top end 108* of the cellular drape 104*, such as suitable features, components, and/or structure for coupling clip 238* to one or both of the drape panels 120, 150 (FIG. 3) or to a corresponding header installed relative to the drape panels 120, 150 (FIG. 3) at the top end 108* of the drape 104*. For instance, as shown in FIGS. 18-20, the drape clip 238* includes first and second clip arms 307*, 309* extending from the mounting tab 296* for coupling the clip 238* to the cellular drape 104*. Specifically, in the illustrated embodiment, the first clip arm 307* includes a clip post 311* configured to extend within a corresponding clip opening 313* defined in the second clip arm 309*. In such an embodiment, when coupling the clip 238* to the cellular drape 104*, the top end 108* of the drape 104* is configured to be positioned between the first and second clip arms 307*, 309* to allow the clip post 311* to be inserted through a corresponding opening (not shown) defined in the drape 104* at or adjacent to the drape's top end 108*. Once the clip post 311* is received through the opening defined in the drape 104*, the clip post 311* may be inserted or snapped into the associated clip opening 313* defined through the second clip arm 309* to secure the clip 238* to the drape 104*. However, it should be appreciated that, in alternative embodiments, the drape clip 238* may have any other suitable configuration that allows it to be coupled between the drape connector 236* and the cellular drape 104* to support the drape 104* relative to the rail 202*.

In several embodiments, a hinged connection may be provided between the first and second clip arms 307*, 309*. For instance, as shown in the illustrated embodiment, an integral or living hinge 375* is provided between the first and second clip arms 307*, 309*. In such an embodiment, to allow the drape clip 268* to be coupled to the drape 104*, one or both of the clip arms 307*, 309* may be pivoted away from the opposed clip arm about the hinged connection to allow the clip 238* to be positioned relative to the top end 108* of the drape 104*. For example, as shown in dashed lines in FIG. 20, the second clip arm 309* has been pivoted away from the first clip arm 307* to a position that allows the top end 108* of the cellular drape 104* to be moved between the first and second clip arms 307*, 309*. Once the cellular drape 104* and drape clip 238* are properly positioned relative to each other, the clip arms 307*, 309* may again be snapped or coupled together around the cellular drape 104* (i.e., via engagement between the clip post 311* and associated opening 313*) to secure the clip 311* to the drape 104*.

It should be appreciated that, as an alternative to the carrier assembly 240B* shown in FIGS. 18-20, the cellular drape 104* may, instead, be configured to be coupled directly to the drape connector 236* as opposed to being coupled to the connector 236* indirectly via the drape clip 238*. For example, in alternative embodiments, each intermediate carrier assembly 240B* may simply include an intermediate carrier 230* and an associated drape connector 236*, with the connector 236* being configured to be coupled directly between the carrier 230* and the cellular drape 104*. In such an embodiment, the bottom connector portion 287* of the drape connector 236* may be configured to define a suitable attachment interface for coupling the connector 236* to the cellular drape 104* at or adjacent to the drape's top end 108*. For example, the top end 108* of the cellular drape 104* may be configured to be coupled to the bottom connector portion 287* in a manner similar to that described above with reference to the drape clip 238*, such as by inserting the top end 108* of the drape 104* through the insertion slit 295* defined through the bottom connector portion 287* until the hooked member 293* extends within a corresponding opening (not shown) defined through the drape 104*. However, it should be appreciated that, in alternative embodiments, the bottom connector portion 287* of the drape connector 236* may have any other suitable configuration that allows it to be coupled to the cellular drape 104* in a manner consistent with the disclosure provided herein.

Referring now to FIGS. 21 and 22, differing views of one embodiment of the end carrier assembly 240A* of the mounting system 200 described above with reference to FIG. 16 is illustrated in accordance with aspects of the present disclosure. Specifically, FIG. 21 illustrates a perspective view of the end carrier assembly 240A* with an adjacent spacer 242* of the disclosed mounting system 200* being installed relative thereto and FIG. 22 illustrates a cross-sectional view of the assembly shown in FIG. 21 taken about line XXII-XXII, with the drape connector 236* and associated clip 238* being removed for purposes of illustration.

As indicated above, in several embodiments, the end carrier assembly 240A* includes an end carrier 228*, a drape connector 236*, and a drape clip 238* of the disclosed mounting system 200*, with the drape connector 236* and drape clip 238* being coupled between the end carrier 228* and a portion of the cellular drape 104* to allow the drape 104* to be supported by the carrier assembly 240A* relative to the rail 202*. It should be appreciated that the drape connector 236* and associated drape clip 238* shown in FIG. 21 are configured the same as the clip 236* and connector 238* described above with reference to FIGS. 18-20. As such, a detailed description of such components of the end carrier assembly 240A* will not be provided below for the sake of brevity.

As shown in FIG. 21, similar to the intermediate carrier 230* described above, the end carrier 228* includes both a base portion 231* and a spacer portion 243*. As will be described below, the base portion 231* may be configured to slidably couple the carrier 228* to the rail 202* within the bottom mounting slot 221*. In addition, the base portion 231* may be configured for coupling the adjacent drape connector 236* to the carrier 288*, as well as coupling the associated operating wand 117* (FIG. 16) of the covering assembly 100* to the carrier 228*. Moreover, as will be described below, the spacer portion 243* of the end carrier 228* may be configured to allow a spacer 242* of the mounting system 200* to be coupled thereto and/or engaged therewith within the interior of the rail 202*.

As shown in FIG. 21, the base portion 231* of the end carrier 228* defines a substantially “U-shaped” profile including a bottom wall 377* and first and second sidewalls 378*, 379* extending vertically from the bottom wall 377*. Similar to the sidewalls 363*, 364* of the base portion 261* of the intermediate carrier 230* described above, the sidewalls 378*, 379* are configured to extend through the mounting slot 221* (FIG. 17) of the rail 202* when the carrier 228* is installed relative to the rail 202*. Additionally, in several embodiments, the end carrier 228* may include one or more track engagement features or structure extending outwardly from the sidewalls 378*, 379* of the base portion 231* for engagement with the track walls 225*, 227* (FIG. 17) of the rail 202*, thereby allowing the carrier 228* to be supported within the mounting slot 221* relative to the rail 202*. Specifically, as shown in the illustrated embodiment, the end carrier 228* includes a series of first and second track flanges 380*, 381* (only one of the second track flanges 381* being shown in FIG. 21) extending outwardly from and spaced apart across the first and second sidewalls 378*, 379* of the base portion 231*, respectively, such that each track flange 380*, 381* is configured to be supported by an adjacent track wall 225*, 227* of the rail 202* when the carrier 228* is installed within the mounting slot 221*. For example, similar to the configuration of the track flanges 365*, 366* described above with reference to the intermediate carrier 230* of FIG. 19, the track flanges 365*, 366* are configured to be supported directly on the upper surfaces of the track walls 225*, 227*, thereby providing a contact interface between the carrier 228* and the rail 202* across which the carrier 228* may be slid or moved along the length of the rail 202*. It should be appreciated, as opposed to including discrete track flanges 365*, 366* spaced across each sidewall 378*, 379*, the base portion 231* of the end carrier 228* may, instead, including a single continuous track flange extending outwardly from each sidewall 378*, 379*.

Additionally, in one embodiment, the end carrier 228* may further include one or more stop flanges 382* spaced vertically below the track flanges 365*, 366* along each sidewall 378*, 379* of the base portion 231* to maintain the vertical positioning of the carrier 228* relative to the rail 202*. Similar to the embodiment of the intermediate carrier 230* described above with reference to FIGS. 18-20, the stop flanges 382* may be positioned vertically below the track flanges 365*, 366* such that, when the carrier 228* is installed within the mounting slot 221*, each track wall 225*, 227* (FIG. 17) is vertically trapped within a gap or channel 383* (FIG. 21) defined between the track/stop flanges positioned along each sidewall 378*, 379*, thereby preventing the carrier 228* from being pushed upwardly into the interior of the rail 202* beyond the position of the stop flanges 382*. In such an embodiment, it should be appreciated that the end carrier 228* may be configured to be installed within the mounting slot 221* by sliding the carrier 230* onto the track 233* (FIG. 17) at one of the ends of the rail 202* such that the track walls 225*, 227* are received within the channel 383* defined between the track/stop flanges.

As indicated above, in addition to slidably coupling the end carrier 238* to the rail 202*, the base portion 231* of the carrier 228* may also be configured to support both the adjacent drape connector 236* and the associated operating wand 117* of the covering assembly 100*. For instance, as particularly shown in FIG. 22, a first pivot opening 384* is defined through the bottom wall 377* of the base portion 231* for pivotably coupling the connector 236* to the carrier 228*. Similar to that described above with reference to FIG. 20, the pivot head 290* of the associated drape connector 236* may be configured to be inserted through the first pivot opening 284* to suspend the drape connector 236* from the carrier 228* in a manner that allows the connector 236* to freely rotate or pivot relative to the carrier 228* about a corresponding vertical pivot axis 288* (FIG. 22). Additionally, as shown in FIG. 22, a second pivot opening 385* is defined through the bottom wall 377* of the base portion 231* for pivotably coupling a wand connector 386* to the carrier 228*. As shown in the illustrated embodiment, the wand connector 286* may include a pivot head 387* (FIG. 22) configured to be inserted through the second pivot opening 385* to suspend the wand connector 286* from the carrier 228* in a manner that allows the connector 286* to rotate or pivot relative to the carrier 228* about a corresponding vertical pivot axis 388*. In such an embodiment, the portion of the wand connector 386* extending outwardly from the end carrier 228* may include or define suitable features or structure for allowing the operating wand 117* to be coupled to the wand connector 386*, such as a by defining a wand opening 389* configured to receive a wand hook 390* (FIG. 16) positioned at the top end of the operating wand 117*. As such, when a user of the disclosed covering assembly 100* grasps the operating wand 117* to pull/push the drape 104* between the extended and retracted positions, the opening/closing force applied to the wand 117* is transmitted to the end carrier assembly 240A* to cause such assembly to be moved relative to the rail 202* in the desired direction.

In several embodiments, the end carrier 228* may define a lateral spacing width 393* (FIG. 22) between the end of the carrier 228* configured to abut against an adjacent intermediate carrier 230* when the drape 104* is moved to the retracted position and the location at which the drape 104* is configured to be suspended from the carrier 228*. Specifically, as shown in FIG. 22, the lateral spacing width 393* is defined between an end face 394* of the end carrier 228* and the pivot axis 288* about which the drape connector 236* is configured to be pivotably coupled to the carrier 228*. As will be described below with reference to FIG. 23, the lateral spacing width 393* may be selected to minimize the overall stacking width of the carrier assemblies 240* when the drape 104* is moved to the retracted position. In one embodiment, the lateral spacing width 393* may be selected so as to be equal or substantially equal to a corresponding lateral thickness 323* (FIG. 23) of the intermediate carriers 228*.

Additionally, as indicated above, the end carrier 228* also includes a spacer portion 243* extending from or positioned relative to the carrier's base portion 231* such that the spacer portion 243* is configured to be disposed the within the interior cavity 220* (FIG. 17) of the rail 202* when the carrier 228* is installed relative to the mounting slot 221*. In general, the spacer portion 243* of the end carrier 228* may be configured to allow the carrier 228* to be coupled to or engaged with one or more of the spacers 242* of the mounting system 200*. For example, as particularly shown in FIG. 22, the spacer portion 243* includes opposed spacer walls 391*, 392* extending outwardly from the base portion 231* of the carrier 228* and an engagement bar or wall 249* extending between the opposed connector walls 391*, 392* at a location spaced apart vertically from the sidewalls 378*, 379* of the base portion 231*. As such, a spacer gap 251* (FIG. 22) is defined vertically between the engagement wall 249* and the top ends of the sidewalls 378*, 379* through which a given spacer 242* of the mounting system 200* is configured to extend to allow the spacer 242* to be slidably coupled to the end carrier 228*.

For example, in the view illustrated in FIG. 21, the end carrier 228* is shown installed relative to the second end 246* of the first spacer 242A* described above with reference to FIGS. 18 and 20. As shown in FIG. 21, the spacer 242A* extends through the spacer gap 251* defined by the spacer portion 243* of the end carrier 228* to allow the carrier 228* to move relative to the spacer 242A* between the spacer's second end 246* and its opposed first end 244* (FIG. 18) (which, as indicated above, may be configured to be coupled to the spacer portion of the adjacent intermediate carrier 230*). As a result, the relative lateral spacing between the end carrier 228* and the immediately adjacent intermediate carrier 230* may vary as the cellular drape 104* is being moved between the extended and retracted positions. Additionally, similar to the embodiment described above, the engagement tab or stop 284* defined at or adjacent to the second end 246* of the spacer 242A* may be configured to prevent the carrier 228* and the spacer 242A* from becoming decoupled from each other. For example, the end carrier 228* may be moved relative to the spacer 242A* towards the spacer's second end 246* until the engagement wall 249* of the carrier 228* contacts or otherwise engages against the stop 284* of the spacer 242A*, thereby preventing further relative movement of the carrier 228* in such direction. Thus, the stop 284* may engage or otherwise contact the engagement bar 249* when the end carrier 228* is moved away from the immediately adjacent intermediate carrier 230* as the cellular drape 104* is being moved to the extended position to allow the end carrier 228* to pull the adjacent intermediate carrier 230* along the length of the rail 202* via the coupling provided by the spacer 242A*.

It should appreciated that, similar to the embodiment of the carrier assemblies 240 described above, the carrier assemblies 240* are generally configured to stack tightly against one another (i.e., in abutting engagement with one another) in the lateral direction 112* of the covering assembly 100* when the cellular drape 104* is moved to the retracted position, thereby allowing the overall lateral profile or width of the drape 104* to be minimized at such position. Specifically, as indicated above, the cellular drape 104* is configured to be collapsed into a folded or accordion-style configuration in the retracted position so that it is capable of taking on a substantially flat profile in the lateral direction 112* of the covering assembly 100* having a desired minimal lateral width 321* (FIG. 15). Accordingly, in one embodiment, to facilitate such collapsing of the cellular drape 104* into the folded or accordion-style configuration, the associated lateral profile or thickness of the stacked carrier assemblies 240* is configured to be minimized as much as possible. It should be appreciated that, when the cellular drape 104* takes on the folded or accordion-style configuration, the drape 104* need not necessarily be fully compressed or collapsed as the drape 104* is moved to the fully retracted position.

For example, FIG. 23 illustrates a perspective view of the stacked configuration that can be achieved with the disclosed carrier assemblies 240* when the cellular drape 104* is moved to the retracted position. As shown, the carrier assemblies 240* are configured to be stacked laterally in an abutting or side-by-side relationship, with the carrier 228*, 230* of each carrier assembly 240* being positioned directly adjacent to and/or contacting the carrier(s) of an adjacent assembly(ies) 240*. In such an embodiment, a lateral thickness 323* of each intermediate carrier assembly 240B*, as well as the lateral spacing width 393* for each end carrier assembly 240A* is selected such that, when the carrier assemblies 240* are stacked in the configuration shown in FIG. 23, an overall lateral thickness 325* of the portion of the assembly stack across which the drape 104* is supported is generally less than or equal to the desired minimal lateral width 321* (FIG. 15) of the cellular drape 104* when in the retracted position. For example, in one embodiment, the lateral thickness 323* of each intermediate carrier assembly 240B* and the lateral spacing width 393* associated with each end carrier assembly 240A* may be minimized to achieve the smallest lateral stack thickness 325* possible.

In the illustrated embodiment, the stack of carrier assemblies 240* is shown as including two end carriers 228* (namely a first end carrier 228A* and a second end carrier 228B*) positioned at opposed ends of the stacked assemblies 240*. As shown in FIG. 23, the first end carrier 228A* corresponds to the end carrier 228* described above with reference to FIGS. 21 and 22 and, thus, is configured to be coupled to both a lateral end of the drape 104* (e.g., via the associated drape connector/clip 236*, 238*) and the operating wand 117* of the covering assembly 100* (e.g., via the wand connector 386*). The second end carrier 228B* is generally configured the same as the first end carrier 228A*, except that the lateral orientation of the carrier 228B* has been flipped such that the end carrier 228B* is configured to support the opposed lateral end of the drape 104* (e.g., via the associated drape connector/clip 236*, 238*) at a location adjacent the neighboring intermediate carrier 230* when the drape 104* is moved to the retracted position, thereby minimizing the lateral spacing width 393* associated with such carrier 228B*. Additionally, as shown in FIG. 23, as opposed to including a feature or structure for coupling an operating wand to the carrier 228B*, the second end carrier 228B* is configured to accommodate a fastener 397* to allow the end carrier 228B* to be fixed in position relative to the rail 202*. However, in embodiments in which both ends of the drape 104* are configured to be moved relative to the adjacent architectural structure, the second end carrier 228B* may, instead, have a different configuration, such as by including a wand connector 386* coupled thereto to allow a second operating wand to be coupled to the end carrier 228B*.

It should be appreciated that, given the configuration of the intermediate carrier assembly 240B* described above with reference to FIGS. 18-20, the lateral thickness 323* of each intermediate carrier assembly 240B* generally corresponds to the lateral thickness or width 395* (FIG. 18) of each intermediate carrier 230*. As such, the disclosed intermediate carriers 230* have been designed in a manner that minimizes their lateral widths 395*, thereby minimizing the lateral thickness 323* of each intermediate carrier assembly 240B*. Moreover, as shown in FIG. 23, each end carrier 228* defines a lateral thickness or width 396* that is significantly larger than the widths 395* (FIG. 18) of the intermediate carriers 230*, primarily to allow the end carrier 228* to support the drape 104*, as well as to accommodate the operating wand 117* of the covering assembly 100* (e.g., via wand connector 386*) and/or accommodate coupling the carrier 228* to the rail 202* (e.g., via the fastener 397*). However, as indicated above, the lateral spacing width 393* for each end carrier 228* is defined between the end face configured to abut against the adjacent intermediate carrier 230* when the drape 104* is moved to the retracted position and the connection point for the drape 104* along the end carrier 228*. As such, by minimizing the lateral spacing width 393*, the collapsibility of the drape 104* is not impacted by the extended overall width 396* of the end carriers 228*.

It should be appreciated that, in general, the lateral thickness 323* of each intermediate carrier assembly 240B* and the lateral spacing width 393* associated with each end carrier assembly 240A* may vary depending on the configuration of the covering assembly 100*, as well as the desired minimal lateral width 321* (FIG. 15) for the cellular drape 104*. However, in a particular embodiment, the lateral thickness 323* and lateral spacing width 393* may be equal to a lateral distance that is less than one inch, such as less than 0.75 inches, or less than 0.50 inches, or less than 0.30 inches, including any thicknesses defined within such range(s) in increments of 0.02 inches. Additionally, in one embodiment, the lateral thickness 323* and lateral spacing width 393* may be equal to a lateral distance that is greater than 0.05 inches, such as greater than 0.10 inches, or greater than 0.15 inches, or greater than 0.20 inches, or greater than 0.30 inches, including any thicknesses defined within such range(s) in increments of 0.02 inches. Moreover, in another embodiment, the lateral thickness 323* and lateral spacing width 393* may be greater than 0.05 inches and less than 1 inch, such as greater than 0.10 inches and less than 0.75 inches, or greater than 0.15 inches and less than 0.50 inches, or greater than 0.20 inches and less than 0.40 inches, or greater than 0.20 inches and less than 0.30 inches, including any thicknesses defined within such range(s) in increments of 0.02 inches. Such a reduced lateral dimension is significantly smaller than prior art assemblies used to support conventional drapes relative to an associated rail.

Moreover, in one embodiment, the lateral thickness 323* of each intermediate carrier assembly 240B* and the lateral spacing width 393* associated with each end carrier assembly 240A* may be equal or substantially equal, thereby allowing the lateral spacing of the connection points between the drape 104* and the carrier assemblies 240* to be uniform when the drape 104* is moved to the retracted position. It should be appreciated that, as used herein, the lateral thickness 323* of each intermediate carrier assembly 240B* and the lateral spacing width 393* associated with each end carrier assembly 240A* are configured to be “substantially equal” when the dimensions differ from each other by less than 10%, such as when the dimensions differ from each other by less than 7.5%, or less than 5%, or less than 2.5%, or less than 1%.

It should also be appreciated that, in general, the lateral thickness 323* of the intermediated carrier assemblies 240B* may be reduced relative to prior art assemblies given the absence of an active pivot system within the disclosed mounting system 200*. Specifically, as indicated above, each drape connector 236* is simply configured to freely or passively pivot relative to the connector's respective carrier 230* as the cellular drape 104* is moved between the extended and retracted positions. As such, without the need for the bulky components typically included within an active pivot system, the various components of the mounting system 200* (including the carrier assemblies 240*) can be designed to be very compact.

As indicated above, with reference to FIG. 17, in addition to the bottom mounting slot 221*, a rear mounting slot 222* may also be defined along the rear side 218* of the rail 202*. In one embodiment, the rear mounting slot 222* may be configured to accommodate an optional support bracket 232* of the covering assembly 100*. For instance, FIG. 24 illustrates an end view of the rail 202* described above with reference to FIG. 17 with a support bracket 232* assembled relative to the rear mounting slot 222*. As shown in FIG. 24, the support bracket 232* is supported relative to the rail 202* using a mounting bracket 399* installed within the rear mounting slot 222* (e.g., via the upper and lower tracks 224A*, 224B*) for sliding movement along the length of the rail 202*. In one embodiment, the support bracket 232* may be configured similar to the support bracket 232 described above with reference to FIGS. 1, 2 and 7. For instance, the support bracket 232* may be used support a corresponding spine or stabilizer configured to provide structural support to the cellular drape 104* (e.g., along one of the drape's lateral sides), such as similar to the stabilizer 119 described above with reference to FIGS. 1 and 2.

While the foregoing Detailed Description and drawings represent various embodiments, it will be understood that various additions, modifications, and substitutions may be made therein without departing from the spirit and scope of the present disclosure. Each example is provided by way of explanation without intent to limit the broad concepts of the present disclosure. In particular, it will be clear to those skilled in the art that principles of the present disclosure may be embodied in other forms, structures, arrangements, proportions, and with other elements, materials, and components, without departing from the spirit or essential characteristics thereof. For instance, features illustrated or described as part of one embodiment can be used with another embodiment to yield a still further embodiment. Thus, it is intended that the present disclosure covers such modifications and variations as come within the scope of the appended claims and their equivalents. One skilled in the art will appreciate that the disclosure may be used with many modifications of structure, arrangement, proportions, materials, and components and otherwise, used in the practice of the disclosure, which are particularly adapted to specific environments and operative requirements without departing from the principles of the present disclosure. For example, elements shown as integrally formed may be constructed of multiple parts or elements shown as multiple parts may be integrally formed, the operation of elements may be reversed or otherwise varied, the size or dimensions of the elements may be varied. The presently disclosed embodiments are therefore to be considered in all respects as illustrative and not restrictive, the scope of the present disclosure being indicated by the appended claims, and not limited to the foregoing description.

In the foregoing Detailed Description, it will be appreciated that the phrases “at least one”, “one or more”, and “and/or”, as used herein, are open-ended expressions that are both conjunctive and disjunctive in operation. The term “a” or “an” element, as used herein, refers to one or more of that element. As such, the terms “a” (or “an”), “one or more” and “at least one” can be used interchangeably herein. All directional references (e.g., proximal, distal, upper, lower, upward, downward, left, right, lateral, longitudinal, front, rear, top, bottom, above, below, vertical, horizontal, cross-wise, radial, axial, clockwise, counterclockwise, and/or the like) are only used for identification purposes to aid the reader's understanding of the present disclosure, and/or serve to distinguish regions of the associated elements from one another, and do not limit the associated element, particularly as to the position, orientation, or use of the present disclosure. Connection references (e.g., attached, coupled, connected, joined, secured, mounted and/or the like) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

All apparatuses and methods disclosed herein are examples of apparatuses and/or methods implemented in accordance with one or more principles of the present disclosure. These examples are not the only way to implement these principles but are merely examples. Thus, references to elements or structures or features in the drawings must be appreciated as references to examples of embodiments of the present disclosure, and should not be understood as limiting the disclosure to the specific elements, structures, or features illustrated. Other examples of manners of implementing the disclosed principles will occur to a person of ordinary skill in the art upon reading this disclosure.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The following claims are hereby incorporated into this Detailed Description by this reference, with each claim standing on its own as a separate embodiment of the present disclosure. In the claims, the term “comprises/comprising” does not exclude the presence of other elements or steps. Furthermore, although individually listed, a plurality of means, elements or method steps may be implemented by, e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc., do not preclude a plurality. Reference signs in the claims are provided merely as a clarifying example and shall not be construed as limiting the scope of the claims in any way.

What is claimed is:

1. A covering assembly for an architectural structure, said covering assembly comprising:
a vertical cellular drape extending in a vertical direction between a top end and a bottom end and in a lateral direction between a first lateral end and a second lateral end, said cellular drape being movable in the lateral direction between an extended position and a retracted position, said cellular drape including a front drape panel defining a front face of said cellular drape and a rear drape panel defining a rear face of said cellular drape opposite said front face, said front and rear faces being spaced apart from each other in a cross-wise direction, said front and rear drape panels defining interleaved pleats between said front and rear faces of said cellular drape; and
a mounting system configured to support said cellular drape relative to an architectural structure, said mounting system comprising:
a rail extending in the lateral direction between a first end and a second end, said rail defining a mounting slot extending laterally between said first and second ends of said rail; and
a plurality of carrier assemblies configured to be coupled between said rail and said cellular drape, each carrier assembly of said plurality of carrier assemblies including a respective carrier slidably mounted within said mounting slot of said rail, said carriers of said plurality of carrier assemblies configured to be moved into abutting engagement with one another when said cellular drape is moved to the retracted position to form an assembly stack;
wherein:
said cellular drape defines a lateral width when said cellular drape is moved to the retracted position; and
a lateral dimension associated with said plurality of carrier assemblies is selected to minimize the lateral width of said cellular drape when said carriers are moved into abutting engagement with one another.

2. The covering assembly of claim 1, wherein:
said interleaved pleats comprise front and rear pleats spaced apart across said front and rear faces, respectively, of said cellular drape; and
said front and rear pleats are provided in an alternating arrangement between said first and second lateral ends of said cellular drape such that said cellular drape is configured to collapse into an accordion-style configuration when moved to the retracted position.

3. The covering assembly of claim 2, wherein:
said front pleats comprise alternating front pleat peaks and front pleat valleys across said front face of said cellular drape;
said rear pleats comprise alternating rear pleat peaks and rear pleat valleys across said rear face of said cellular drape; and
when said cellular drape is moved to the extended position, each of said front pleat peaks is substantially aligned with a corresponding rear pleat valley in the cross-wise direction of said covering assembly and each of said rear pleat peaks is substantially aligned with a corresponding front pleat valley in the cross-wise direction of said covering assembly.

4. The covering assembly of claim 1, wherein said carriers of said plurality of carrier assemblies comprise a plurality of intermediate carriers configured to be coupled to said cellular drape at spaced apart locations in the lateral direction between said first and second lateral ends of said cellular drape and an end carrier configured to be coupled to said cellular drape adjacent to one of said first lateral end or said second lateral end.

5. The covering assembly of claim 4, wherein the lateral dimension comprises a lateral thickness of each of said intermediate carriers.

6. The covering assembly of claim 5, wherein:
the lateral dimension further comprises a lateral spacing width associated with said end carrier; and
the lateral spacing width is defined between an end face of said end carrier configured to abut against an adjacent intermediate carrier when said cellular drape is moved to the retracted position and a location at which said cellular drape is coupled to said end carrier.

7. The covering assembly of claim 6, wherein the lateral spacing width associated with said end carrier is substantially equal to the lateral thickness of each of said intermediate carriers.

8. The covering assembly of claim 1, wherein:
each carrier assembly comprises a drape connector coupled between said cellular drape and said respective carrier of said carrier assembly; and
said drape connector is configured to freely pivot relative to said respective carrier about a vertical pivot axis as said cellular drape is being moved between the extended and retracted positions.

9. The covering assembly of claim 1, wherein:
said mounting system further comprises a plurality of spacers installed relative to one of said rail or said cellular drape;
each spacer extends lengthwise between a first end and a second end and defines a spacer length between said first and second ends; and
said spacer length is selected to set a maximum peak-to-peak distance defined between adjacent front pleats or adjacent rear pleats of said interleaved pleats when said cellular drape is moved to the extended position.

10. The covering assembly of claim 9, wherein each spacer is positioned within an interior cavity of said rail and is engaged between adjacent carriers of said plurality of carrier assemblies or each spacer is coupled between an adjacent pair of pleats of said interleaved pleats of said cellular drape.

11. A covering assembly for an architectural structure, said covering assembly comprising:
a vertical cellular drape extending in a vertical direction between a top end and a bottom end and in a lateral direction between a first lateral end and a second lateral end, said cellular drape being movable in the lateral direction between an extended position and a retracted position, said cellular drape including a front drape panel defining a front face of said cellular drape and a rear drape panel defining a rear face of said cellular drape opposite said front face, said front and rear faces being spaced apart from each other in a cross-wise direction, said front and rear drape panels defining interleaved pleats between said front and rear faces of said cellular drape; and
a mounting system configured to support said cellular drape relative to an architectural structure, said mounting system comprising:
a rail extending in the lateral direction between a first end and a second end, said rail defining a mounting slot extending laterally between said first and second ends of said rail;
a plurality of carrier assemblies configured to be coupled between said rail and said cellular drape, each carrier assembly of said plurality of carrier assemblies including a carrier mounted within said mounting slot of said rail; and
a plurality spacers installed relative to one of said rail or said cellular drape, each spacer extending lengthwise between a first end and a second end;
wherein:
each spacer defines a spacer length between said first and second ends; and
the spacer length is selected to set a maximum peak-to-peak distance defined between adjacent pleats of said interleaved pleats when said cellular drape is moved to the extended position.

12. The covering assembly of claim 11, wherein:
said interleaved pleats comprise front and rear pleats spaced apart across said front and rear faces, respectively, of said cellular drape; and
said front and rear pleats are provided in an alternating arrangement between said first and second lateral ends of said cellular drape such that said cellular drape is configured to collapse into an accordion-style configuration when moved to the retracted position.

13. The covering assembly of claim 12, wherein:
said front pleats comprise alternating front pleat peaks and front pleat valleys across said front face of said cellular drape;
said rear pleats comprise alternating rear pleat peaks and rear pleat valleys across said rear face of said cellular drape; and
when said cellular drape is moved to the extended position, each of said front pleat peaks is substantially aligned with a corresponding rear pleat valley in the cross-wise direction of said covering assembly and each of said rear pleat peaks is substantially aligned with a corresponding front pleat valley in the cross-wise direction of said covering assembly.

14. The covering assembly of claim 11, wherein each spacer is positioned within an interior cavity of said rail and is engaged between an adjacent pair of carriers of said plurality of carrier assemblies.

15. The covering assembly of claim 11, wherein each spacer is non-slidably engaged with a first carrier of each said adjacent pair of carriers at said first end and is slidably engaged with a second carrier of each said adjacent pair of carriers between said first and second ends to allow for relative movement between said first and second carriers along the lateral direction of said covering assembly.

16. The covering assembly of claim 11, wherein each spacer is coupled between said adjacent pleats of said interleaved pleats of said cellular drape.

17. The covering assembly of claim 16, wherein said adjacent pair of pleats comprises adjacent rear pleats of a plurality of rear pleats of said interleaved pleats such that said plurality of spacers are positioned along said rear face of said cellular drape.

18. The covering assembly of claim 17, wherein said plurality spacers are coupled across said plurality of rear pleats along said top end of said cellular drape or said plurality of spacers wrap around said plurality of rear pleats across said rear face of said cellular drape.

19. The covering assembly of claim 11, wherein:
said carriers of said plurality of carrier assemblies are configured to be moved into abutting engagement with one another when said cellular drape is moved to the retracted position to form an assembly stack;
said cellular drape defines a lateral width when said cellular drape is moved to the retracted position; and
a lateral dimension associated with said plurality of carrier assemblies is selected to minimize the lateral width of said cellular drape when said carriers are moved into abutting engagement with one another.

20. The covering assembly of claim 19, wherein:
said carriers of said plurality of carrier assemblies comprise a plurality of intermediate carriers configured to be coupled to said cellular drape at spaced apart locations in the lateral direction between said first and second lateral ends of said cellular drape and an end carrier configured to be coupled to said cellular drape adjacent to one of said first lateral end or said second lateral end;
the lateral dimension comprises a lateral thickness of each of said intermediate carriers and a lateral spacing width associated with said end carrier; and
the lateral spacing width is defined between an end face of said end carrier configured to abut against an adjacent intermediate carrier when said cellular drape is moved to the retracted position and a location at which said cellular drape is coupled to said end carrier.
